(19) United States
(12) Patent Application Publication
(10) Pub. No.: US 2024/0336080 A1
(43) Pub. Date: Oct. 10, 2024

(54) THERMAL TRANSFER SHEET

(71) Applicant: DAI NIPPON PRINTING CO., LTD., Tokyo (JP)

(72) Inventor: Emi MORI, Tokyo (JP)

(73) Assignee: DAI NIPPON PRINTING CO., LTD., Tokyo (JP)

(21) Appl. No.: 18/576,780

(22) PCT Filed: Jul. 7, 2022
(86) PCT No.: PCT/JP2022/026968

§ 371 Date: Jan. 5, 2024

(30) Foreign Application Priority Data
Jul. 7, 2021 (JP) 2021-112980

(51) Int. Cl. B41M 5/382; B41M 5/385

(52) U.S. Cl. CPC B41M 5/38257; B41M 5/385; B41M 2205/02; B41M 2205/06; B41M 2205/30

(57) ABSTRACT

A thermal transfer sheet including: a first substrate; and a first transfer layer and a peel-off layer provided on one surface of the first substrate in a frame sequential manner, wherein the first transfer layer after transfer under the following condition (A) has an arithmetic mean height Sa of more than 0.1 μm and less than 0.6 μm, and the peel-off layer has an arithmetic mean height Sa of more than 0.1 μm and less than 1.0 μm,
[Condition (A)]
an intermediate transfer medium including a receiving layer having a surface with an arithmetic mean height Sa of 0.1 μm is prepared, and the first transfer layer of the thermal transfer sheet is placed opposite the receiving layer of the intermediate transfer medium, and an application energy of 0.167 mJ/dot is applied to transfer the first transfer layer of the thermal transfer sheet to a surface of the receiving layer of the intermediate transfer medium.

### TECHNICAL FIELD

The present disclosure relates to a thermal transfer sheet, a combination of a thermal transfer sheet and a peel-off sheet, a method for producing a printed material, a method for peeling off a transfer layer, a printing apparatus, and a peel-off apparatus.

### BACKGROUND ART

One proposed method for forming a thermal transfer image on an arbitrary object includes preparing an intermediate transfer medium with a transfer layer provided on a support so as to be separable from the support, forming a thermal transfer image on the transfer layer of the intermediate transfer medium using a thermal transfer sheet with a coloring material layer, and then transferring the transfer layer onto a transfer target.

Depending on the type of printed material formed using an intermediate transfer medium, it may be necessary to leave a region for providing an IC chip portion, a magnetic stripe portion, a transmitting/receiving antenna portion, a signature portion, or the like. More specifically, it may be necessary to remove a portion of a transfer layer corresponding to the above-mentioned region before transferring a transfer layer onto a transfer target.

A proposed method of removing a portion of a transfer layer includes using a peel-off sheet with a peel-off layer provided on one surface of a substrate to remove the transfer layer in a region where transfer to a transfer target is not desired at a stage before a transfer layer of an intermediate transfer medium is transferred onto the transfer target (for example, see Patent Literature 1).

### CITATION LIST

### Patent Literature

PTL 1: Japanese Unexamined Patent Application Publication No. 2003-326865

### SUMMARY OF INVENTION

### Technical Problem

In the method using the peel-off sheet, it is important to accurately remove a portion of the transfer layer by the peel-off layer, that is, the peel-off property. An object of the present disclosure is to provide a thermal transfer sheet with good peel-off property, and a combination of a thermal transfer sheet and a peel-off sheet with good peel-off property. An object of the present disclosure is to improve the peel-off property in a method for producing a printed material including removing a desired portion of a transfer layer of an intermediate transfer medium and then transferring the transfer layer onto a transfer target. An object of the present disclosure is to improve the peel-off property in a method for peeling off a transfer layer including removing a desired portion of a transfer layer of an intermediate transfer medium. An object of the present disclosure is to provide a printing apparatus that can be suitably used in the method for producing a printed material. An object of the present disclosure is to provide a peel-off apparatus that can be suitably used for the peel-off method.

### Solution to Problem

A thermal transfer sheet according to the present disclosure includes a first substrate, and a first transfer layer and a peel-off layer provided on one surface of the first substrate in a frame sequential manner. The first transfer layer after transfer under the condition (A) described later may have an arithmetic mean height Sa of more than 0.1 μm and less than 0.6 μm. The peel-off layer may have an arithmetic mean height Sa of more than 0.1 μm and less than 1.0 μm.

A combination according to the present disclosure is a combination of a thermal transfer sheet and a peel-off sheet. The thermal transfer sheet includes a second substrate and a second transfer layer provided on one surface of the second substrate. The second transfer layer after transfer may have an arithmetic mean height Sa of more than 0.1 μm and less than 0.6 μm. The peel-off sheet includes a third substrate and a peel-off layer provided on one surface of the third substrate. The peel-off layer may have an arithmetic mean height Sa of more than 0.1 μm and less than 1.0 μm.

A method for producing a printed material according to the present disclosure includes the steps of: (1) preparing at least a thermal transfer sheet and an intermediate transfer medium including a third transfer layer; (2) removing a portion of the third transfer layer; and (3) transferring the third transfer layer a portion of which is removed onto a transfer target. The step (1) may include preparing the thermal transfer sheet as a first thermal transfer sheet and the intermediate transfer medium, or preparing the combination of the thermal transfer sheet and the peel-off sheet as a combination of a second thermal transfer sheet and a peel-off sheet, and the intermediate transfer medium. The intermediate transfer medium includes a support and a third transfer layer provided on one surface of the support so as to be separable from the support. A portion of the third transfer layer is a region to be removed in the step (2). The step (2) may include, in order, transferring a first transfer layer or a second transfer layer from the first thermal transfer sheet or the second thermal transfer sheet onto at least a portion of the region to be removed of the third transfer layer in the intermediate transfer medium, and removing, by the first thermal transfer sheet or the peel-off layer of the peel-off sheet, the region to be removed of the third transfer layer together with the first transfer layer or the second transfer layer transferred onto the region to be removed.

A method for peeling off a transfer layer according to the present disclosure includes the steps of: (1) preparing at least a thermal transfer sheet and an intermediate transfer medium including a third transfer layer; and (2) removing a portion of the third transfer layer. The step (1) may include preparing the thermal transfer sheet as a first thermal transfer sheet and the intermediate transfer medium, or preparing the combination of the thermal transfer sheet and the peel-off sheet as a combination of a second thermal transfer sheet and a peel-off sheet, and the intermediate transfer medium. The intermediate transfer medium includes a support and a third transfer layer provided on one surface of the support so as to be separable from the support. A portion of the third transfer layer is a region to be removed in the step (2). The step (2) may include, in order, transferring a first transfer layer or a second transfer layer from the first thermal transfer sheet or the second thermal transfer sheet onto at least a portion of the region to be removed of the third transfer layer in the intermediate transfer medium, and removing, by the first thermal transfer sheet or the peel-off layer of the peel-off sheet, the region to be removed of the third transfer layer together with the first transfer layer or the second transfer layer transferred onto the region to be removed.

A printing apparatus according to the present disclosure includes: a first supply unit for supplying an intermediate transfer medium including a support and a third transfer layer provided on one surface of the support so as to be separable from the support; a second supply unit for supplying the thermal transfer sheet or the combination of the thermal transfer sheet and the peel-off sheet; a printing unit for heating the thermal transfer sheet, transferring a first transfer layer or a second transfer layer of the thermal transfer sheet onto at least a portion of a region to be removed of the third transfer layer, and removing the region to be removed of the third transfer layer by the thermal transfer sheet or the peel-off layer of the peel-off sheet after the transfer of the first transfer layer or the second transfer layer; a third supply unit for supplying a transfer target; and a transfer unit for transferring the third transfer layer from which the region to be removed in the intermediate transfer medium is removed onto the transfer target.

A peel-off apparatus according to the present disclosure includes: a first supply unit for supplying an intermediate transfer medium including a support and a third transfer layer provided on one surface of the support so as to be separable from the support; a second supply unit for supplying the thermal transfer sheet or the combination of the thermal transfer sheet and the peel-off sheet; and a peel-off unit for heating the thermal transfer sheet, transferring a first transfer layer or a second transfer layer of the thermal transfer sheet onto at least a portion of a region to be removed of the third transfer layer, and removing the region to be removed of the third transfer layer by the thermal transfer sheet or the peel-off layer of the peel-off sheet after the transfer of the first transfer layer or the second transfer layer.

### Advantageous Effects of Invention

The present disclosure can provide a thermal transfer sheet with good peel-off property, and a combination of a thermal transfer sheet and a peel-off sheet with good peel-off property. The present disclosure can improve the peel-off property in a method for producing a printed material including removing a desired portion of a transfer layer of an intermediate transfer medium and then transferring the transfer layer onto a transfer target. The present disclosure can improve the peel-off property in a method for peeling off a transfer layer including removing a desired portion of a transfer layer of an intermediate transfer medium. The present disclosure can provide a printing apparatus that can be suitably used in the method for producing a printed material. The present disclosure can provide a peel-off apparatus that can be suitably used for the peel-off method.

### BRIEF DESCRIPTION OF DRAWINGS

FIG. 1 is a schematic cross-sectional view of a thermal transfer sheet according to an embodiment.

FIG. 2 is a schematic cross-sectional view of a thermal transfer sheet according to an embodiment.

FIG. 3 is a schematic cross-sectional view of a combination of a thermal transfer sheet and a peel-off sheet according to an embodiment.

FIG. 4 is a process cross-sectional view for explaining a method for producing a printed material according to an embodiment.

FIG. 5 is a process cross-sectional view for explaining a method for producing a printed material according to an embodiment.

FIG. 6 is a process cross-sectional view for explaining a method for producing a printed material according to an embodiment.

FIG. 7 is a cross-sectional view of an intermediate transfer medium from which a region of a transfer layer to be removed is removed.

FIG. 8 is a schematic view of an example of a thermal transfer printer used in a method for producing a printed material according to an embodiment.

### DESCRIPTION OF EMBODIMENTS

Embodiments of the present disclosure are described in detail below. The present disclosure can be implemented in many different forms and is not to be construed as limited to the description of the following embodiments. In the drawings, for the sake of clarity, the width, thickness, shape, and the like of each layer may be more schematic than those in the embodiments, and the drawings are only examples and do not limit the interpretation of the present disclosure. In the present description and drawings, the same reference numerals are given to the same elements as those already described with reference to the previous drawings, and detailed description thereof may be appropriately omitted.

In the present disclosure, when a plurality of upper limit candidates and a plurality of lower limit candidates are described for a certain parameter, the numerical range of the parameter may be configured by combining any one of the upper limit candidates and any one of the lower limit candidates. For example, the following explanation is given to the phrase “The parameter B is preferably A1 or more, more preferably A2 or more, still more preferably A3 or more. The parameter B is preferably A4 or less, more preferably A5 or less, still more preferably A6 or less.” In this example, the numerical range of the parameter B may be A1 or more and A4 or less, A1 or more and A5 or less, A1 or more and A6 or less, A2 or more and A4 or less, A2 or more and A5 or less, A2 or more and A6 or less, A3 or more and A4 or less, A3 or more and A5 or less, or A3 or more and A6 or less.

### [Thermal Transfer Sheet]

A first thermal transfer sheet according to the present disclosure includes a first substrate, and a first transfer layer and a peel-off layer provided on one surface of the first substrate in a frame sequential manner. The first thermal transfer sheet can be used to perform a primary transfer step and a transfer layer removing step described later using one thermal transfer sheet.

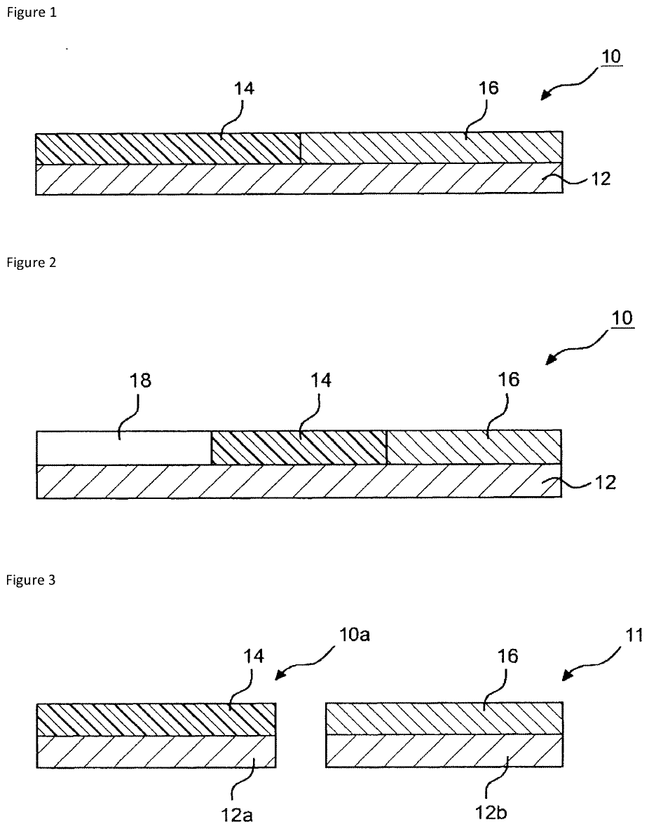

FIG. 1 is a schematic cross-sectional view of a first thermal transfer sheet according to an embodiment. A thermal transfer sheet 10 includes a first substrate 12, and a first transfer layer 14 and a peel-off layer 16 provided on one surface of the first substrate 12. The first transfer layer 14 and the peel-off layer 16 are provided on one surface of the first substrate 12 in a frame sequential manner.

### (Substrate)

A first thermal transfer sheet according to the present disclosure includes a first substrate.

The first substrate is, for example, a paper substrate or a resin substrate. The paper substrate is, for example, glassine paper, capacitor paper, or paraffin paper. The resin substrate is a substrate composed of a resin material. The resin material is, for example, a polyester, a polyamide, a polyimide, a polycarbonate, a polyolefin, a polystyrene, a vinyl resin, a vinyl acetal resin, a (meth)acrylic resin, a cellulose resin, or an ionomer resin. The polyester is, for example, poly(ethylene terephthalate), poly(butylene terephthalate), poly(ethylene naphthalate), 1,4-poly(cyclohexylenedimethylene terephthalate), or a terephthalic acid-cyclohexanedimethanol-ethylene glycol copolymer. The polyolefin is, for example, polyethylene, polypropylene, or polymethylpentene. The vinyl resin is, for example, poly(vinyl chloride), poly(vinyl acetate), a vinyl chloride-vinyl acetate copolymer, poly(vinyl alcohol), or polyvinylpyrrolidone. The vinyl acetal resin is, for example, poly(vinyl acetoacetal) or poly(vinyl butyral). The (meth)acrylic resin is, for example, poly(meth)acrylate. The cellulose resin is, for example, cellophane, cellulose acetate, nitrocellulose, cellulose acetate propionate, or cellulose acetate butyrate. The resin substrate can contain one or two or more resin materials.

In the present disclosure, “(meth)acrylic” encompasses both “acrylic” and “methacrylic”, and “(meth)acrylate” encompasses both “acrylate” and “methacrylate”.

Among these resin materials, from the perspective of heat resistance and mechanical strength, a polyester is preferred, poly(ethylene terephthalate) (PET) or poly(ethylene naphthalate) (PEN) is more preferred, and PET is still more preferred.

The first substrate may be a laminate of resin substrates. The laminate of resin substrates can be produced, for example, by a dry lamination method, a wet lamination method, or an extrusion method.

The resin substrate may be a stretched film or an unstretched film. In terms of strength, a uniaxially or biaxially stretched film is preferred.

The first substrate may be subjected to surface treatment. The surface treatment method is, for example, corona discharge treatment, flame treatment, ozone treatment, ultraviolet treatment, radiation treatment, surface roughening treatment, chemicals treatment, plasma treatment, low-temperature plasma treatment, primer treatment, or grafting treatment.

The first substrate preferably has a thickness of 1 μm or more, more preferably 2 μm or more, still more preferably 3 μm or more. The first substrate preferably has a thickness of 100 μm or less, more preferably 50 μm or less, still more preferably 25 μm or less. This can improve, for example, the mechanical strength of the first substrate and the transfer of thermal energy during thermal transfer.

### (First Transfer Layer)

A first thermal transfer sheet according to the present disclosure includes a first transfer layer.

The first transfer layer has an arithmetic mean height Sa of more than 0.1 μm and less than 0.6 μm (above 0.1 μm and below 0.6 μm). The first transfer layer preferably has an Sa of 0.2 μm or more, more preferably 0.25 μm or more. The first transfer layer preferably has an Sa of less than 0.5 μm, more preferably 0.48 μm or less, still more preferably 0.45 μm or less.

A first transfer layer with an Sa of more than 0.1 μm has a rough surface structure with a sufficiently large roughness height and has a large contact area with a peel-off layer at the time of peeling off. This can improve the peel-off property. At an Sa of less than 0.6 μm, in a printed material including a metal-pigment-containing layer described later as a first transfer layer, the metal-pigment-containing layer imparts design performance. At an Sa of less than 0.5 μm, in a printed material including a metal-pigment-containing layer described later as a first transfer layer, the metal-pigment-containing layer imparts higher design performance. The design performance is, for example, gloss, brilliancy, or pearliness. Thus, an Sa of more than 0.1 μm and less than 0.5 μm can result in good peel-off property and high design performance. Sa can be adjusted in this range, for example, by appropriately adjusting the particle content and the average particle size of a metal-based pigment or the like and the thickness of a first transfer layer.

In the present disclosure, after a first transfer layer is transferred onto a receiving layer of an intermediate transfer medium, the Sa of the first transfer layer is measured on a surface of the first transfer layer opposite the receiving layer.

The Sa of the first transfer layer is measured under the following specific transfer conditions. A thermal transfer sheet including a first transfer layer and an intermediate transfer medium including a receiving layer having a surface with an arithmetic mean height Sa of 0.1 μm are prepared. The first transfer layer of the thermal transfer sheet is placed opposite the receiving layer of the intermediate transfer medium, and an application energy of 0.167 mJ/dot is applied to transfer the first transfer layer of the thermal transfer sheet to the entire surface of the receiving layer of the intermediate transfer medium. At this time, the arithmetic mean height Sa of the surface of the transferred first transfer layer is measured. More specifically, a printer described below is used to apply an energy of 255/255 gray scale for the transfer. More detailed transfer conditions here are specifically described in the section of [Production of Printed Material] in Examples.

### (Printer)

Thermal head: KEE-57-12GAN2-STA (manufactured by Kyocera Corporation)
Average resistance of heating element: 3303 (Ω)
Print density in main scanning direction: 300 (dpi)
Print density in sub-scanning direction: 300 (dpi)
One line cycle: 2.0 (ms)
Printing start temperature: 35 (° C.)
Pulse duty ratio: 85%
Applied voltage: 18 (V)

The applied energy (mJ/dot) is an applied energy calculated using the following formula (1), and the applied electric power [W] in the formula (1) can be calculated using the following formula (2).

$$Applied energy ( mJ / dot ) = W \times L . S \times P . D \times grayscale value \qquad ( Formula ( 1 ) )$$

In the formula 1, [W] denotes the applied electric power, [L.S] denotes the line cycle (milliseconds/line), and [P.D] denotes the pulse duty.

$$Applied electric power ( W / dot ) = {V}^{2} / R \qquad ( Formula ( 2 ) )$$

In the formula 2, [V] denotes the applied voltage, and [R] denotes the resistance of a heating means.

In the present disclosure, the arithmetic mean height Sa is a parameter that is measured in accordance with ISO 25178, represents an average of absolute difference in height at each point on an average plane of the surface, and serves as a measure of surface roughness. Details of the measurement conditions are described in Examples.

The first transfer layer is provided so as to be separable from the first substrate.

In one embodiment, the first transfer layer is a layer to be transferred onto at least a portion of a region to be removed of a third transfer layer of an intermediate transfer medium. In one embodiment, the first transfer layer is melted or softened by heating and is transferred onto a third transfer layer of an intermediate transfer medium. Due to its high thermal conductivity, a metal-pigment-containing layer as the first transfer layer can efficiently transfer heat from a peel-off layer to a third transfer layer of an intermediate transfer medium and can further improve the peel-off property. This can reduce, for example, energy applied from the thermal transfer printer side.

In one embodiment, the first transfer layer contains particles of a metal-based pigment or the like and a binder. In one embodiment, the first transfer layer is a metal-pigment-containing layer containing a metal-based pigment and a binder.

The first transfer layer can have, for example, a rough surface structure due to particles. More specifically, the particle content and the average particle size of the first transfer layer and the thickness of the first transfer layer may be appropriately adjusted. This allows, for example, the arithmetic mean height of the first transfer layer to be adjusted in the range described above.

The particles are, for example, organic particles or inorganic particles.

The organic particles are, for example, particles formed of a resin (resin particles). The resin forming the resin particles may be a thermosetting resin or a thermoplastic resin, for example, a melamine resin, a benzoguanamine resin, a phenolic resin, a silicone resin, a urethane resin, an amide resin, a (meth)acrylic resin, a fluoropolymer, a styrene resin, an olefin resin, or a copolymer of monomers constituting these resins. These resins may be used alone or in combination.

The inorganic particles are, for example, a metal-based pigment, a clay mineral, a carbonate, a hydroxide, a sulfate, a silicate, graphite, niter, or boron nitride. The clay mineral is, for example, talc, kaolin, or clay. The carbonate is, for example, calcium carbonate or magnesium carbonate. The hydroxide is, for example, aluminum hydroxide or magnesium hydroxide. The sulfate is, for example, calcium sulfate or barium sulfate. The silicate is, for example, aluminum silicate or magnesium silicate.

The particles are preferably a metal-based pigment. A metal-based pigment can be used to improve the thermal conductivity of the first transfer layer. The metal-based pigment is, for example, a metal pigment, a metal oxide pigment, or a coated pigment.

The metal pigment is, for example, particles composed of a metal, such as aluminum, iron, titanium, zirconium, silicon, cerium, nickel, chromium, brass, tin, brass, bronze, zinc, silver, platinum, gold, or indium. The metal oxide pigment is, for example, particles composed of an oxide of the metal.

Among the metal pigments, from the perspective of improving the thermal conductivity of a metal-pigment-containing layer, aluminum particles are preferred, and a flaky aluminum pigment, that is, aluminum flakes are more preferred.

The aluminum pigment may be of a leafing type or a non-leafing type. An aluminum pigment of the non-leafing type is preferred from the perspective that the aluminum pigment uniformly dispersed in a metal-pigment-containing layer can increase the thermal conductivity of the metal-pigment-containing layer.

The metal-based pigment preferably has a hiding power of 2.0 or more or 2.5 or more. In one embodiment, this can reduce the influence on the color of an image formed on a printed material. The metal-based pigment may have a hiding power of 6.0 or less or 5.5 or less. In the present disclosure, the hiding power of a metal-based pigment is measured in accordance with JIS K5600-4-1: 1999.

The coated pigment includes a core material and a coating material, such as a metal or a metal oxide, for covering the core material.

A material constituting the core material of the coated pigment may be an inorganic material or an organic material. The inorganic material is, for example, natural mica, synthetic mica, glass, aluminum, or alumina. The organic material is, for example, a resin material, such as a polyester, a polyamide, a polyolefin, a vinyl resin, or a (meth)acrylic resin.

The coating material is, for example, a metal, such as aluminum, iron, titanium, zirconium, silicon, cerium, nickel, chromium, brass, tin, brass, bronze, zinc, silver, platinum, gold, or indium, or an oxide of the metal. The oxide of the metal is, for example, titanium oxide or iron oxide. The coating material for covering the core material can be formed, for example, by vapor deposition.

In one embodiment, the coating material is preferably a metal from the perspective of improving the brightness of a printed material. The coating material preferably contains gold or silver and is more preferably composed of gold or silver. This can improve, for example, the brightness of a printed material.

In one embodiment, the core material preferably contains glass and is more preferably composed of glass. In one embodiment, the coating material is preferably a metal. The coating material preferably contains gold or silver and is more preferably composed of gold or silver. In one embodiment, the coated pigment is particles of glass coated with a metal, more specifically particles of glass coated with gold or silver. This can improve, for example, the brightness of a printed material with little influence on the color of the coating material.

In one embodiment, the core material preferably contains mica and is more preferably composed of mica. In one embodiment, the coating material is preferably a metal oxide. The coating material preferably contains titanium oxide or iron oxide and is more preferably composed of titanium oxide or iron oxide. In one embodiment, the coated pigment is particles of mica coated with a metal oxide, more specifically particles of mica coated with titanium oxide or iron oxide. This can improve, for example, the glossiness of a printed material.

The shape of the particles of a metal-based pigment or the like is, for example, spherical, needle-like, or flaky.

The particles of a metal-based pigment or the like preferably have an average particle size of 1 μm or more, more preferably 3 μm or more. The particles of a metal-based pigment or the like preferably have an average particle size of 100 μm or less, more preferably 40 μm or less. This can improve, for example, the peel-off property, the thermal conductivity, that is, the peel-off property of a metal-pigment-containing layer when the first transfer layer is the metal-pigment-containing layer, and the design performance of a printed material.

In the present disclosure, the average particle size of a pigment or particles refers to a volume-average particle size and is measured with a particle size distribution/particle diameter distribution analyzer (Nanotrac particle size distribution analyzer, manufactured by Nikkiso Co., Ltd.) in accordance with JIS Z 8819-2: 2019.

In one embodiment, the metal pigment or the metal oxide pigment preferably has an average particle size of 4 μm or more, more preferably 4.5 μm or more. In one embodiment, the metal pigment or the metal oxide pigment preferably has an average particle size of 10 μm or less, more preferably 9.5 μm or less. This can, for example, improve the thermal conductivity of the metal-pigment-containing layer, harden the metal-pigment-containing layer, and therefore improve the peel-off property. For example, this can reduce the occurrence of a fine residue of the transfer layer at the time of peeling off.

In one embodiment, the coated pigment preferably has an average particle size of 3 μm or more, more preferably 5 μm or more. In one embodiment, the coated pigment preferably has an average particle size of 100 μm or less, more preferably 40 μm or less. This can improve, for example, the thermal conductivity of the metal-pigment-containing layer, the peel-off property, and the design performance of a printed material.

When the metal-based pigment is flaky particles, the metal-based pigment may have a particle thickness of 0.5 μm or more and 10 μm or less. This can further improve the transferability of the thermal transfer sheet. The thickness of the particles of the metal-based pigment can be measured by extracting a predetermined number (preferably 100 or more) of flaky particles from a particle group to be measured and measuring the thickness of the flaky particles using an electron microscope.

The first transfer layer can contain one or two or more types of particles.

The particle content of the first transfer layer is preferably 23% by mass or more, more preferably 33% by mass or more. The particle content of the first transfer layer is preferably 83% by mass or less, more preferably 67% by mass or less. This can improve, for example, the peel-off property.

The metal-pigment-containing layer contains one or two or more metal-based pigments.

The metal-based pigment content of the metal-pigment-containing layer is preferably 23% by mass or more, more preferably 33% by mass or more. The metal-based pigment content of the metal-pigment-containing layer is preferably 83% by mass or less, more preferably 67% by mass or less. This can improve, for example, the thermal conductivity of the metal-pigment-containing layer.

The binder is, for example, a resin material or a wax.

The resin material is, for example, a (meth)acrylic resin, an ethylene-vinyl acetate copolymer, an ethylene-(meth)acrylate copolymer, a poly(vinyl chloride) resin, a vinyl acetate resin, a vinyl chloride-vinyl acetate copolymer, a vinylidene chloride resin, a polyolefin, a polystyrene, a polyester, a polyamide, a polycarbonate, poly(vinyl alcohol), poly(vinyl formal), poly(vinyl butyral), a cellulose resin, a petroleum resin, a fluoropolymer, an epoxy resin, or an ionomer resin. The polyolefin is, for example, polyethylene, polypropylene, polybutene, or polyisobutylene. The cellulose resin is, for example, cellulose acetate, nitrocellulose, or ethylcellulose.

The wax is, for example, a microcrystalline wax, carnauba wax, a paraffin wax, a Fischer-Tropsch wax, a low-molecular-weight polyethylene, Japan wax, beeswax, spermaceti, insect wax, lanolin, shellac wax, candelilla wax, petrolatum, a polyester wax, a partially modified wax, a fatty acid ester, or a fatty acid amide.

The binder is preferably a resin material, more preferably a (meth)acrylic resin, a vinyl chloride-vinyl acetate copolymer, or a polyester, still more preferably a vinyl chloride-vinyl acetate copolymer.

In one embodiment, the first transfer layer is a melt transfer resin layer.

The first transfer layer can contain one or two or more binders.

The binder content of the first transfer layer is preferably 17% by mass or more, more preferably 33% by mass or more. The binder content of the first transfer layer is preferably 77% by mass or less, more preferably 67% by mass or less. This can improve, for example, the transferability of the first transfer layer and the adhesiveness to a third transfer layer of an intermediate transfer medium.

The ratio of the particle content of a metal-based pigment or the like to the binder content in the first transfer layer (PV ratio=the particle content of a metal-based pigment or the like/the binder content) is preferably 0.3 or more, more preferably 0.4 or more, based on mass. The ratio (PV ratio) in the first transfer layer is preferably 5.0 or less, more preferably 1.8 or less, still more preferably 1.5 or less, based on mass. This can improve, for example, the transferability and thermal conductivity of the first transfer layer, and the adhesiveness to a third transfer layer of an intermediate transfer medium. A PV ratio of 1.8 or less tends to result in a printed material with high design performance.

The first transfer layer may contain one or two or more additive agents. The additive agent is, for example, a filler, a plasticizer, an antistatic agent, an ultraviolet absorber, inorganic particles, organic particles, a release agent, or a dispersant.

The first transfer layer preferably has a thickness of 0.1 μm or more, more preferably 0.2 μm or more. The first transfer layer preferably has a thickness of 10 μm or less, more preferably 7 μm or less, still more preferably 4.5 μm or less. This can improve, for example, the peel-off property when a region to be removed of a third transfer layer of an intermediate transfer medium is removed by a peel-off layer.

In one embodiment, the thickness of the first transfer layer is smaller than the thickness of a peel-off layer. This can improve, for example, the peel-off property. For example, when the first transfer layer is transferred onto a third transfer layer in the form of a dot or line, the contact between a non-transfer region of the first transfer layer and a peel-off layer can be improved in the transfer layer removing step described later.

### (Peel-Off Layer)

A first thermal transfer sheet according to the present disclosure includes a peel-off layer.

In one embodiment, the peel-off layer is a layer for removing a portion of a third transfer layer of an intermediate transfer medium. In the present disclosure, the portion of the third transfer layer to be finally removed by the peel-off layer is also referred to as a “region to be removed” of the third transfer layer.

The peel-off layer has an arithmetic mean height Sa of more than 0.1 μm and less than 1.0 μm (above 0.1 μm and below 1.0 μm). The peel-off layer preferably has an Sa of 0.15 μm or more, more preferably 0.2 μm or more, still more preferably 0.4 μm or more. Sa is preferably 0.8 μm or less, more preferably 0.6 μm or less. The peel-off layer with an Sa of more than 0.1 μm has a rough surface structure with a sufficiently large roughness height and has a large contact area with the first transfer layer at the time of peeling off. This can improve the peel-off property. An Sa of less than 1.0 μm can result in a smaller decrease in the coatability of a coating liquid for a peel-off layer and satisfactory formation of the peel-off layer. For example, Sa can be adjusted in the above range by appropriately adjusting the particle content and the average particle size in each layer (particularly in the peel-off layer) and the thickness of the peel-off layer.

In the present disclosure, the arithmetic mean height Sa of the peel-off layer is measured on a surface of the peel-off layer opposite the first substrate.

The reason for the good peel-off property in the present disclosure is not clear, but is presumed as described below. When the surface area of a peel-off layer with a rough surface structure is compared with the surface area of a peel-off layer with no rough surface structure, the surface area of the peel-off layer with the rough surface structure is larger. This also applies to the first transfer layer. When a third transfer layer of an intermediate transfer medium is removed, energy is applied to a thermal transfer sheet or a peel-off sheet from a heating member. The application of energy softens the peel-off layer and the first transfer layer that was previously transferred onto the third transfer layer of the intermediate transfer medium as described later. The peel-off layer and the first transfer layer have a rough surface structure and are considered to have a large contact area therebetween. The increase in the contact area contributes to the improvement of the peel-off property. It should be noted that the above description is a conjecture and does not limit the present disclosure.

In one embodiment, the peel-off layer contains a resin material, such as a thermoplastic resin. The resin material is, for example, a polyolefin, a poly(vinyl chloride) resin, a vinyl chloride-vinyl acetate copolymer, a (meth)acrylic resin, a styrene-(meth)acrylic resin, a styrene-vinyl chloride-vinyl acetate copolymer, a polyester, a polyamide, a butyral resin, or an epoxy resin.

The peel-off layer can contain one or two or more resin materials.

Among the resin materials, from the perspective of the peel-off property, at least one selected from a polyester, a vinyl chloride-vinyl acetate copolymer, and a (meth)acrylic resin is preferred and, for example, a mixed resin of a vinyl chloride-vinyl acetate copolymer and a (meth)acrylic resin is preferred.

In the present disclosure, the vinyl chloride-vinyl acetate copolymer refers to a copolymer of vinyl chloride and vinyl acetate. The vinyl chloride-vinyl acetate copolymer may contain a constitutional unit derived from another copolymerization component.

The vinyl chloride-vinyl acetate copolymer preferably has a number-average molecular weight (Mn) of 5,000 or more, more preferably 7,000 or more. The vinyl chloride-vinyl acetate copolymer preferably has Mn of 50,000 or less, more preferably 43,000 or less. The peel-off layer containing the vinyl chloride-vinyl acetate copolymer with the above Mn has, for example, a better peel-off property. In the present disclosure, Mn refers to a value measured by gel permeation chromatography using a standard polystyrene and is measured by a method according to JIS K 7252-3: 2016.

The vinyl chloride-vinyl acetate copolymer preferably has a glass transition temperature (Tg) of 50° C. or more, more preferably 60° C. or more. The vinyl chloride-vinyl acetate copolymer preferably has Tg of 90° C. or less, more preferably 80° C. or less. The peel-off layer containing the vinyl chloride-vinyl acetate copolymer with the above Tg has, for example, a better peel-off property. In the present disclosure, Tg is a glass transition temperature determined by differential scanning calorimetry (DSC) in accordance with JIS K 7121: 2012.

The (meth)acrylic resin has a weight-average molecular weight (Mw) of, for example, 20,000 or more. The (meth)acrylic resin has a weight-average molecular weight (Mw) of, for example, 50,000 or less. The peel-off layer containing the (meth)acrylic resin with the above Mw has, for example, a better peel-off property. In the present disclosure, Mw refers to a value measured by gel permeation chromatography using a standard polystyrene and is measured by a method according to JIS K 7252-3: 2016.

The (meth)acrylic resin has a Tg of, for example, 80° C. or more. The (meth)acrylic resin has a Tg of, for example, 120° C. or less. The peel-off layer containing the (meth)acrylic resin with the above Tg has, for example, a better peel-off property.

In the present disclosure, the (meth)acrylic resin content per 100 parts by mass of the total amount of the vinyl chloride-vinyl acetate copolymer and the (meth)acrylic resin in the peel-off layer may be 10 parts by mass or more or 30 parts by mass or more. The (meth)acrylic resin content per 100 parts by mass of the total amount of the vinyl chloride-vinyl acetate copolymer and the (meth)acrylic resin in the peel-off layer may be 90 parts by mass or less or 70 parts by mass or less. This can improve, for example, the peel-off property.

In one embodiment, the peel-off layer contains at least one selected from a vinyl chloride-vinyl acetate copolymer and a polyester, preferably contains at least one selected from a vinyl chloride-vinyl acetate copolymer and a crystalline polyester, and may contain a vinyl chloride-vinyl acetate copolymer and a crystalline polyester. This can improve, for example, the peel-off property.

In the present disclosure, the crystalline polyester refers to a polyester with a clear melting peak measured with a differential scanning calorimeter in at least one of two temperature rise processes in which the temperature is raised from −100° C. to 300° C. at 10° C./min, then lowered from 300° C. to −100° C. at 5° C./min, and subsequently raised from −100° C. to 300° C. at 10° C./min.

The crystalline polyester preferably has a melting point of 50° C. or more, more preferably 80° C. or more. The crystalline polyester preferably has a melting point of 150° C. or less, more preferably 120° C. or less. This can more remarkably improve, for example, the peel-off property. In the present disclosure, the melting point is a melting peak temperature determined by differential scanning calorimetry (DSC) in accordance with JIS K 7121: 2012.

The peel-off layer may contain one or two or more additive agents. The additive agent is, for example, a filler, a plasticizer, an ultraviolet absorber, inorganic particles, organic particles, or a dispersant.

In one embodiment, the peel-off layer contains particles. The peel-off layer can have, for example, a rough surface structure due to the particles. Thus, for example, the arithmetic mean height of the peel-off layer can be adjusted in the above range.

The peel-off layer can contain one or two or more types of particles.

The particles are, for example, organic particles or inorganic particles.

The organic particles are, for example, particles formed of a resin (resin particles). The resin forming the resin particles may be a thermosetting resin or a thermoplastic resin, for example, a melamine resin, a benzoguanamine resin, a phenolic resin, a silicone resin, a urethane resin, an amide resin, a (meth)acrylic resin, a fluoropolymer, a styrene resin, an olefin resin, or a copolymer of monomers constituting these resins. These resins may be used alone or in combination.

The inorganic particles are, for example, a clay mineral, a carbonate, a hydroxide, a sulfate, a silicate, an oxide, graphite, niter, or boron nitride. The clay mineral is, for example, talc, kaolin, or clay. The carbonate is, for example, calcium carbonate or magnesium carbonate. The hydroxide is, for example, aluminum hydroxide or magnesium hydroxide. The sulfate is, for example, calcium sulfate or barium sulfate. The silicate is, for example, aluminum silicate or magnesium silicate. The oxide is, for example, silica, alumina, zinc oxide, titanium oxide, zirconium oxide, or magnesium oxide.

The shape of the particles may be any of an irregular shape, a spherical shape, an elliptical shape, a cylindrical shape, a prismatic shape, and the like. The particles may have a surface treated with a surface treatment material, such as a silane coupling agent.

The particles preferably have an average particle size of 0.1 μm or more, more preferably 0.2 μm or more, still more preferably 0.3 μm or more, particularly preferably 0.8 μm or more. The particles preferably have an average particle size of 10 μm or less, more preferably 5 μm or less, still more preferably 4 μm or less, particularly preferably 3 μm or less. Thus, for example, the arithmetic mean height of the peel-off layer can be adjusted in the above range, and the peel-off property can be improved.

The ratio of the particle content to the resin material content in the peel-off layer (PV ratio=the particle content/the resin material content) is preferably 0.01 or more, more preferably 0.03 or more, still more preferably 0.05 or more, based on mass. The ratio (PV ratio) in the peel-off layer is preferably 0.5 or less, more preferably 0.4 or less, still more preferably 0.3 or less, based on mass. This can improve, for example, the peel-off property due to the peel-off layer.

The peel-off layer preferably has a thickness of 0.1 μm or more, more preferably 0.2 μm or more. This can improve, for example, the film strength of the peel-off layer, the adhesiveness to a layer in contact with the peel-off layer, or the adhesion between the peel-off layer and an intermediate transfer medium. The peel-off layer preferably has a thickness of 15 μm or less, more preferably 10 μm or less.

### (Primer Layer)

In one embodiment, a first thermal transfer sheet according to the present disclosure may include a primer layer between the first substrate and the peel-off layer. When the first thermal transfer sheet includes a sublimation transfer coloring material layer as a coloring material layer described later, the first thermal transfer sheet may include a primer layer between the coloring material layer and the first substrate. This can improve the interlayer adhesion between the first substrate and the peel-off layer and the interlayer adhesion between the sublimation transfer coloring material layer and the first substrate.

In one embodiment, the primer layer contains a resin material. The resin material is, for example, a polyester, a vinyl resin, a (meth)acrylic resin, a polystyrene, a polyamide, a polyether, a urethane resin, or a cellulose resin. Among these, a polyester is preferred from the perspective of the adhesion between the first substrate and the peel-off layer.

The primer layer can contain one or two or more resin materials.

In one embodiment, the primer layer between the first substrate and the peel-off layer contains particles. The primer layer has, for example, a rough surface structure due to the particles. More specifically, the particle content and average particle size in the primer layer and the thickness of the primer layer may be appropriately adjusted. Thus, the peel-off layer can have a rough surface structure matching the rough surface structure of the primer layer. Thus, for example, the arithmetic mean height of the peel-off layer can be adjusted in the above range.

The particles are described in detail above.

The primer layer can contain one or two or more types of particles.

The primer layer may contain one or two or more of the additive agents.

The primer layer has a thickness of, for example, 0.05 μm or more. The primer layer has a thickness of, for example, 2 μm or less.

### (Coloring Material Layer)

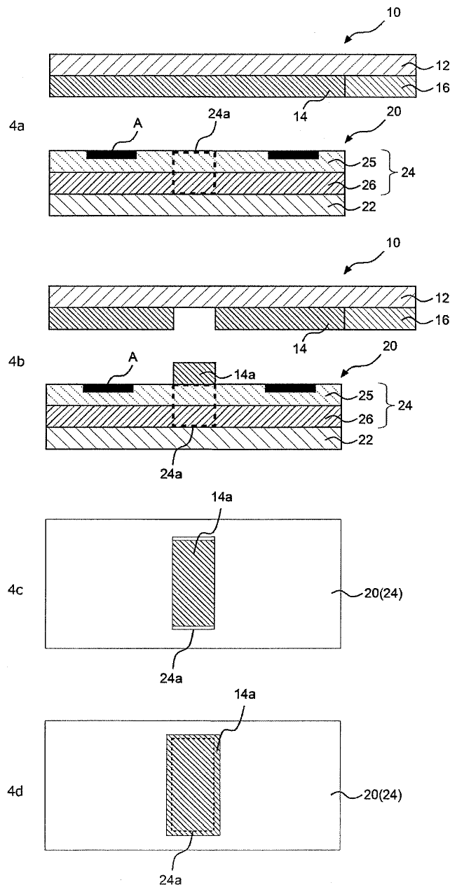

In one embodiment, a first thermal transfer sheet according to the present disclosure may further include a coloring material layer on one surface of the first substrate. In this embodiment, the coloring material layer, the first transfer layer, such as a metal-pigment-containing layer, and the peel-off layer are provided in a frame sequential manner on one surface of the first substrate. FIG. 2 illustrates an example of the thermal transfer sheet according to the present embodiment. A thermal transfer sheet 10 includes a first substrate 12, and a coloring material layer 18, a first transfer layer 14, such as a metal-pigment-containing layer, and a peel-off layer 16 provided on one surface of the first substrate 12 in a frame sequential manner.

Such a first thermal transfer sheet can be used to form a thermal transfer image on a third transfer layer of an intermediate transfer medium. Thus, the formation of the thermal transfer image on a third transfer layer of an intermediate transfer medium and the transfer of the first transfer layer onto the third transfer layer can be simultaneously performed by using the first thermal transfer sheet including at least the coloring material layer and the first transfer layer without using another thermal transfer sheet including the coloring material layer.

The coloring material layer is used to form an image. The coloring material layer contains a coloring material. The coloring material may be a pigment or a dye. The dye may be a sublimation dye.

The coloring material layer may be a sublimation transfer coloring material layer to which a sublimation coloring material, such as a sublimation dye, in the coloring material layer is to be transferred, or may be a melt transfer coloring material layer to which the coloring material layer itself is to be transferred. The thermal transfer sheet may include both the sublimation transfer coloring material layer and the melt transfer coloring material layer.

For example, when a thermal transfer image is formed by a sublimation thermal transfer method, the coloring material layer is a sublimation transfer coloring material layer containing a sublimation dye and a binder resin.

The sublimation dye preferably has a sufficient coloring density and is not discolored or faded by light, heat, or the like. Such a sublimation dye is, for example, a color dye, such as a red dye, a yellow dye, or a blue dye. The sublimation transfer coloring material layer can contain one or two or more sublimation dyes. The sublimation dye content of the sublimation transfer coloring material layer is preferably 5% by mass or more, more preferably 10% by mass or more. The sublimation dye content of the sublimation transfer coloring material layer is preferably 80% by mass or less, more preferably 70% by mass or less.

The binder resin in the sublimation transfer coloring material layer is, for example, a cellulose resin, a vinyl resin, a vinyl acetal resin, a (meth)acrylic resin, a urethane resin, a polyamide, a polyimide, or a polyester. The sublimation transfer coloring material layer can contain one or two or more binder resins. The binder resin content of the sublimation transfer coloring material layer is preferably 20% by mass or more, more preferably 30% by mass or more. The binder resin content of the sublimation transfer coloring material layer is preferably 75% by mass or less, more preferably 60% by mass or less.

The sublimation transfer coloring material layer may be cured by a curing agent. The curing agent is, for example, an epoxy resin, an isocyanate, or a carbodiimide. One or two or more curing agents may be used.

For example, when a thermal transfer image is formed by a melt thermal transfer method, the coloring material layer is a melt transfer coloring material layer containing a colorant and a binder resin.

The colorant preferably has a sufficient coloring density and is not discolored or faded by light, heat, or the like. Examples thereof include an organic pigment, an inorganic pigment, and a dye. The color of the colorant is, for example, but not limited to, cyan, magenta, yellow, or black, and various colors may be used. The melt transfer coloring material layer can contain one or two or more colorants. The colorant content of the melt transfer coloring material layer is preferably 10% by mass or more, more preferably 20% by mass or more. The colorant content of the melt transfer coloring material layer is preferably 60% by mass or less, more preferably 50% by mass or less.

The binder resin in the melt transfer coloring material layer is, for example, a polyolefin, a vinyl resin, a vinyl acetal resin, a (meth)acrylic resin, a polystyrene, a polycarbonate, a cellulose resin, or a petroleum resin. The melt transfer coloring material layer can contain one or two or more binder resins. The binder resin content of the melt transfer coloring material layer is preferably 20% by mass or more, more preferably 30% by mass or more. The binder resin content of the melt transfer coloring material layer is preferably 75% by mass or less, more preferably 60% by mass or less.

The melt transfer coloring material layer may further contain a known wax.

The coloring material layer may contain one or two or more of the additive agents.

A first thermal transfer sheet according to the present disclosure may include one coloring material layer on one surface of the first substrate or may include a plurality of coloring material layers with different hues, for example, a yellow coloring material layer, a magenta coloring material layer, a cyan coloring material layer, and a black coloring material layer in a frame sequential manner.

In one embodiment, a first thermal transfer sheet according to the present disclosure includes a dye layer composed of a yellow (Y) layer, a magenta (M) layer, and a cyan (C) layer, a black (BK) melt transfer coloring material layer, the first transfer layer, such as a metal-pigment-containing layer, and the peel-off layer provided on one surface of the first substrate. In one embodiment of a first thermal transfer sheet according to the present disclosure, a Y layer, a M layer, a C layer, a BK layer, the first transfer layer (for example, a metal-pigment-containing layer), and the peel-off layer are provided on the first substrate in a frame sequential manner.

The coloring material layer has a thickness of, for example, 0.1 μm or more. The coloring material layer has a thickness of, for example, 30 μm or less, preferably 20 μm or less, more preferably 10 μm or less.

### (Release Layer)

In one embodiment, a first thermal transfer sheet according to the present disclosure may include a release layer between the first substrate and the first transfer layer. When the first thermal transfer sheet includes the melt transfer coloring material layer as a coloring material layer, the first thermal transfer sheet may include the release layer between the first substrate and the melt transfer coloring material layer. This can improve, for example, the separability of the first transfer layer and the melt transfer coloring material layer from the first substrate.

The release layer is a layer that does not constitute the first transfer layer or the melt transfer coloring material layer and is a layer that remains on the first substrate side when the first transfer layer or the melt transfer coloring material layer is transferred.

In one embodiment, the release layer contains a resin material. The resin material is, for example, a vinyl resin, a vinyl acetal resin, a (meth)acrylic resin, a polyester, a polyamide, a polyimide, a urethane resin, a cellulose resin, a silicone resin, or a fluoropolymer. The vinyl resin is, for example, poly(vinyl alcohol). The vinyl acetal resin is, for example, poly(vinyl acetal). The release layer can contain one or two or more resin materials. The resin material content of the release layer is preferably 50% by mass or more.

The release layer may contain a release agent. The release agent is, for example, a fluorine compound, a phosphate compound, a higher fatty acid amide compound, a metallic soap, silicone oil, or a wax. The wax is, for example, a polyethylene wax or a paraffin wax. The release layer can contain one or two or more release agents. The release agent content of the release layer is preferably 0.1% by mass or more, more preferably 0.5% by mass or more. The release agent content of the release layer is preferably 10% by mass or less, more preferably 5% by mass or less.

The release layer may contain one or two or more of the additive agents.

The release layer preferably has a thickness of 0.1 μm or more. This can improve, for example, the transferability. The release layer preferably has a thickness of 3 μm or less, more preferably 2 μm or less.

### (Back Layer)

In one embodiment, a first thermal transfer sheet according to the present disclosure may include a back layer on a surface of the first substrate opposite the first transfer layer. This can reduce, for example, the occurrence of sticking and wrinkling due to heating at the time of thermal transfer or peeling off.

In one embodiment, the back layer contains a resin material. The resin material is, for example, a polyolefin, a polystyrene, a vinyl resin, a (meth)acrylic resin, a vinyl acetal resin, a silicone resin, a polyester, a polyamide, a polyimide, a urethane resin, or a cellulose resin. The vinyl acetal resin is, for example, poly(vinyl butyral) or poly(vinyl acetoacetal). The back layer can contain one or two or more resin materials. The resin material content of the back layer is preferably 10% by mass or more, more preferably 15% by mass or more.

The back layer may be a layer formed by cross-linking a resin material having a reactive group, such as a hydroxy group, using a cross-linker, such as a polyisocyanate. The polyisocyanate is, for example, xylene diisocyanate, toluene diisocyanate, isophorone diisocyanate, or hexamethylene diisocyanate. One or two or more cross-linkers can be used.

The back layer may contain a release agent. The release agent is, for example, a fluorine compound, a phosphate compound, a higher fatty acid amide compound, a metallic soap, silicone oil, or a wax. The wax is, for example, a polyethylene wax or a paraffin wax. This can improve, for example, the slipperiness. The back layer can contain one or two or more release agents. The release agent content of the back layer is preferably 0.5% by mass or more. The release agent content of the back layer is preferably 20% by mass or less, more preferably 12% by mass or less.

The back layer may contain one or two or more additive agents. The additive agent is, for example, a plasticizer, an ultraviolet absorber, inorganic particles, organic particles, or a dispersant. The additive agent content per 100 parts by mass of the resin material in the back layer is preferably 0.1 parts by mass or more, more preferably 0.5 parts by mass or more. The additive agent content per 100 parts by mass of the resin material in the back layer is preferably 25 parts by mass or less, more preferably 20 parts by mass or less.

The back layer preferably has a thickness of 0.1 μm or more, more preferably 0.3 μm or more. The back layer preferably has a thickness of 5 μm or less, more preferably 3 μm or less. This can improve, for example, the heat resistance of a thermal transfer sheet.

### [Combination of Thermal Transfer Sheet and Peel-Off Sheet]

A combination according to the present disclosure is a combination of a second thermal transfer sheet and a peel-off sheet.

The second thermal transfer sheet constituting the combination according to the present disclosure includes a second substrate and a second transfer layer, such as a metal-pigment-containing layer, provided on one surface of the second substrate. The peel-off sheet constituting the combination according to the present disclosure includes a third substrate and a peel-off layer provided on one surface of the third substrate. When the second thermal transfer sheet and the peel-off sheet are used, a primary transfer step described later can be performed using the second thermal transfer sheet, and the transfer layer removing step can be performed using the peel-off sheet.

FIG. 3 illustrates a schematic cross-sectional view of the combination according to one embodiment. A second thermal transfer sheet 10a includes a second substrate 12a and a second transfer layer 14, such as a metal-pigment-containing layer, provided on one surface of the second substrate 12a. A peel-off sheet 11 includes a third substrate 12b and a peel-off layer 16 provided on one surface of the third substrate 12b.

The second thermal transfer sheet has the same structure as the first thermal transfer sheet except that the peel-off layer is not provided. The second substrate is the same as the first substrate. The second transfer layer is the same as the first transfer layer. Thus, each layer constituting the second thermal transfer sheet is not described here.

The peel-off sheet includes a third substrate. The third substrate may be the same as the first substrate constituting the first thermal transfer sheet. Thus, the third substrate is not described in detail here.

In one embodiment, the third substrate constituting the peel-off sheet contains particles. The third substrate has, for example, a rough surface structure due to the particles. More specifically, the particle content and the average particle size of the third substrate and the thickness of the third substrate may be appropriately adjusted. Thus, the surface of the peel-off layer can have a shape matching the rough surface structure of the third substrate. Thus, for example, the arithmetic mean height of the peel-off layer can be adjusted in the above range.

The particles are described in detail above.

The third substrate can contain one or two or more types of particles.

The peel-off sheet includes a peel-off layer. In one embodiment, the peel-off sheet may include a primer layer between the third substrate and the peel-off layer. In one embodiment, the peel-off sheet may include a back layer on a surface of the third substrate opposite the peel-off layer. The peel-off layer, the primer layer, and the back layer are the same as the peel-off layer, the primer layer, and the back layer in the first thermal transfer sheet, respectively. Thus, these layers are not described in detail here.

### [Intermediate Transfer Medium]

An intermediate transfer medium used in a method for producing a printed material described later includes a support and a transfer layer. More specifically, the intermediate transfer medium includes a support and a third transfer layer provided on one surface of the support so as to be separable from the support. A portion of the third transfer layer is a region to be removed by a peel-off layer in the step (2) described later.

A schematic cross-sectional view of an intermediate transfer medium according to an embodiment is shown in a portion of the process drawing of FIG. 4. An intermediate transfer medium 20 includes a support 22 and a third transfer layer 24 provided on one surface of the support 22. The third transfer layer 24 includes a separation layer 26 and a receiving layer 25 in this order from the support 22 side in the thickness direction of the intermediate transfer medium 20. The receiving layer 25 is located on the outermost surface of the intermediate transfer medium 20 and is located farthest from the support 22 among the layers constituting the third transfer layer 24.

### (Support)

The support may be the same as the first substrate.

### (Third Transfer Layer)

In one embodiment, the third transfer layer includes a receiving layer. The third transfer layer may have a monolayer structure composed of the receiving layer or a multilayer structure including the receiving layer and another layer. When the third transfer layer has the multilayer structure, the receiving layer constitutes a surface layer of the third transfer layer opposite the support.

In one embodiment, the third transfer layer includes a separation layer and a receiving layer in this order in the thickness direction from the support side. In one embodiment, the third transfer layer includes a separation layer, a protective layer, and a receiving layer in this order in the thickness direction from the support side.

### <<Receiving Layer>>

In one embodiment, the receiving layer constitutes a surface layer on one side of the intermediate transfer medium.

For example, a printed material having the third transfer layer including the receiving layer on which a thermal transfer image is formed on a transfer target is produced by forming the thermal transfer image on the receiving layer using a thermal transfer sheet having a coloring material layer and then transferring the third transfer layer including the receiving layer onto the transfer target.

In one embodiment, the receiving layer contains a resin material. The resin material is, for example, a polyolefin, a vinyl resin, a polyester, a polystyrene, a (meth)acrylic resin, a polyamide, a polyimide, a polycarbonate, a urethane resin, a cellulose resin, or an ionomer resin. The polyolefin is, for example, polyethylene or polypropylene. The vinyl resin is, for example, poly(vinyl chloride), poly(vinyl acetate), or a vinyl chloride-vinyl acetate copolymer. The polyester is, for example, poly(ethylene terephthalate) or poly(ethylene naphthalate).

The receiving layer can contain one or two or more resin materials.

The resin material content of the receiving layer is preferably 80% by mass or more, more preferably 85% by mass or more. This can improve, for example, the receptivity of a sublimation dye. The resin material content of the receiving layer is preferably 99% by mass or less, more preferably 98% by mass or less.

In one embodiment, the receiving layer contains a release agent. This can improve, for example, the releasability between the receiving layer and the thermal transfer sheet.

The release agent is, for example, a fluorine compound, a phosphate compound, a higher fatty acid amide compound, a metallic soap, silicone oil, or a wax. The wax is, for example, a polyethylene wax or a paraffin wax. Among these, silicone oil is preferred from the perspective of the releasability.

The silicone oil is, for example, a straight silicone oil or a modified silicone oil. The straight silicone oil is, for example, dimethyl silicone oil or methylphenyl silicone oil. The modified silicone oil is, for example, an amino-modified silicone oil, an epoxy-modified silicone oil, a carboxy-modified silicone oil, a (meth)acryl-modified silicone oil, a mercapto-modified silicone oil, a carbinol-modified silicone oil, a fluorine-modified silicone oil, a methylstyryl-modified silicone oil, or a polyether-modified silicone oil. The modified silicone oil may be of one-end type, both-end type, or side-chain one-end type.

The receiving layer can contain one or two or more release agents.

The release agent content of the receiving layer is preferably 0.5% by mass or more. This can improve, for example, the releasability. The release agent content of the receiving layer is preferably 20% by mass or less, more preferably 10% by mass or less.

The receiving layer may contain an additive agent. The additive agent is, for example, a plasticizer, an ultraviolet absorber, inorganic particles, organic particles, or a dispersant. The receiving layer can contain one or two or more additive agents. The additive agent content per 100 parts by mass of the resin material in the receiving layer is preferably 0.1 parts by mass or more, more preferably 0.5 parts by mass or more. The additive agent content per 100 parts by mass of the resin material in the receiving layer is preferably 20 parts by mass or less, more preferably 10 parts by mass or less.

The receiving layer preferably has a thickness of 0.5 μm or more, more preferably 1 μm or more. This can improve, for example, the density of a thermal transfer image formed on the receiving layer. The receiving layer preferably has a thickness of 20 μm or less, more preferably 10 μm or less.

### <<Separation Layer>>

In one embodiment, the third transfer layer in the intermediate transfer medium includes a separation layer as a surface layer on the support side. This can improve, for example, the separability of the third transfer layer from the support when the third transfer layer is transferred from the intermediate transfer medium. The separation layer is a layer to be transferred from the intermediate transfer medium onto a transfer target.

In one embodiment, the separation layer contains a resin material. The resin material is, for example, a polyolefin, a vinyl resin, a polystyrene, a (meth)acrylic resin, a polyester, a polyamide, a polyimide, a polycarbonate, a cellulose resin, or an ionomer resin. The separation layer can contain one or two or more resin materials.

The separation layer may contain one or two or more of the release agents.

The separation layer may contain one or two or more of the additive agents.

The separation layer preferably has a thickness of 0.1 μm or more, more preferably 0.5 μm or more. This can improve, for example, the durability of the separation layer. The separation layer preferably has a thickness of 8 μm or less, more preferably 5 μm or less.

### <<Protective Layer>>

In one embodiment, the third transfer layer in the intermediate transfer medium includes a protective layer on the surface of the receiving layer on the support side or between the separation layer and the receiving layer.

In one embodiment, the protective layer contains a resin material. The resin material is, for example, a polyester, a polystyrene, a urethane resin, a (meth)acrylic resin, or a (meth)acrylic polyol resin. The protective layer can contain one or two or more resin materials.

The protective layer may contain one or two or more of the additive agents.

The protective layer preferably has a thickness of 0.5 μm or more, more preferably 1 μm or more. This can improve, for example, the durability of the protective layer. The protective layer preferably has a thickness of 7 μm or less, more preferably 5 μm or less.

The layers described above may be formed by any method. For example, each layer can be formed by preparing a coating liquid containing each component exemplified above, applying the coating liquid onto an object on which each layer is to be formed by a known means, and drying the coating liquid. The means is, for example, a roll coating method, a reverse roll coating method, a gravure coating method, a reverse gravure coating method, a bar coating method, or a rod coating method.

### [Method for Producing Printed Material and Method for Peeling off Transfer Layer]

A method for producing a printed material according to the present disclosure includes the steps of: (1) preparing at least a thermal transfer sheet and an intermediate transfer medium including a third transfer layer; (2) removing a portion of the third transfer layer; and (3) transferring the third transfer layer a portion of which is removed onto a transfer target.

A method for peeling off a transfer layer according to the present disclosure includes the steps of: (1) preparing at least a thermal transfer sheet and an intermediate transfer medium including a third transfer layer; and (2) removing a portion of the third transfer layer.

### (Step (1))

In the step (1), a first thermal transfer sheet according to the present disclosure and an intermediate transfer medium are prepared, or a combination of a second thermal transfer sheet and a peel-off sheet according to the present disclosure and an intermediate transfer medium are prepared. Each sheet and the intermediate transfer medium are described in detail above.

In the step (1), the intermediate transfer medium in which a thermal transfer image is already formed on the third transfer layer may be used, or a thermal transfer image may be formed on the third transfer layer of the intermediate transfer medium. More specifically, in one embodiment, a method for producing a printed material and a method for peeling off a transfer layer according to the present disclosure include a step of forming a thermal transfer image on the third transfer layer (more specifically, a receiving layer) of the intermediate transfer medium. In the embodiment illustrated in FIG. 4, a thermal transfer image is formed in advance on the receiving layer of the intermediate transfer medium.

A specific example of the image forming step is described below. An intermediate transfer medium with a receiving layer and a thermal transfer sheet with a coloring material layer are superimposed so that the receiving layer and the coloring material layer face each other. Thermal energy is then applied to the back side of the thermal transfer sheet using a heating member, such as a thermal head. The application of energy transfers a sublimation dye contained in a sublimation transfer coloring material layer to the receiving layer or transfers a melt transfer coloring material layer onto the receiving layer. Thus, a thermal transfer image is formed. A thermal transfer image may be formed using the first thermal transfer sheet or second thermal transfer sheet with a coloring material layer or using another thermal transfer sheet.

A thermal transfer image may be formed before the transfer layer removing step or after a region to be removed of the third transfer layer is removed in the transfer layer removing step. A thermal transfer image may be formed in at least a portion of a region to be removed of the third transfer layer.

### (Step (2))

The step (2) includes, in order, transferring the first transfer layer or the second transfer layer from the first thermal transfer sheet or the second thermal transfer sheet onto at least a portion of the region to be removed of the third transfer layer in the intermediate transfer medium (a primary transfer step), and removing, by the first thermal transfer sheet or the peel-off layer of the peel-off sheet, the region to be removed of the third transfer layer together with the first transfer layer or the second transfer layer transferred onto the region to be removed (a transfer layer removing step).

### <<Primary Transfer Step>>

In the primary transfer step, for example, the first transfer layer or the second transfer layer of the thermal transfer sheet is placed opposite the third transfer layer of the intermediate transfer medium, thermal energy is applied to the back side of the thermal transfer sheet using a heating member, such as a thermal head, and the first transfer layer or the second transfer layer corresponding to the region to which the thermal energy is applied is transferred onto at least a portion of the region to be removed of the third transfer layer.

In a method for producing a printed material and a method for peeling off a transfer layer according to the present disclosure, before the region to be removed of the third transfer layer is removed by the peel-off layer, the first transfer layer or the second transfer layer is transferred in advance onto at least a portion of the region to be removed of the third transfer layer. This can improve the peel-off property when the region to be removed of the third transfer layer is removed by the peel-off layer. A method for producing a printed material and a method for peeling off a transfer layer according to the present disclosure can improve the peel-off property as compared with a method for removing the region to be removed of the third transfer layer by the peel-off layer without transferring the first transfer layer or the second transfer layer onto the region to be removed.

For example, the first transfer layer or the second transfer layer transferred onto at least a portion of the region to be removed of the third transfer layer improves the adhesion between the third transfer layer and the peel-off layer at the time of peeling off. When the first transfer layer or the second transfer layer is a metal-pigment-containing layer, it also has high thermal conductivity. This improves the thermal conductivity from the heating member at the time of peeling off and further improves the peel-off efficiency. This improves the peel-off property at the time of removing the region to be removed of the third transfer layer together with the transferred first transfer layer or second transfer layer by the peel-off layer. Thus, a method for producing a printed material according to the present disclosure can transfer the third transfer layer from which the region to be removed is accurately removed onto a transfer target. The region to be removed of the third transfer layer can be accurately removed by a method for peeling off a transfer layer according to the present disclosure.

The region to be removed, that is, the third transfer layer to be removed by the peel-off layer may have any size, shape, or the like. The region to be removed of the third transfer layer is, for example, a region corresponding to an outer peripheral portion of the third transfer layer or an IC chip portion, a magnetic stripe portion, a transmission and reception antenna portion, a signature portion, or the like of a transfer target. This region can be removed from the third transfer layer to form an image on a transfer target and prevent a desired region of the transfer target from being covered with the third transfer layer.

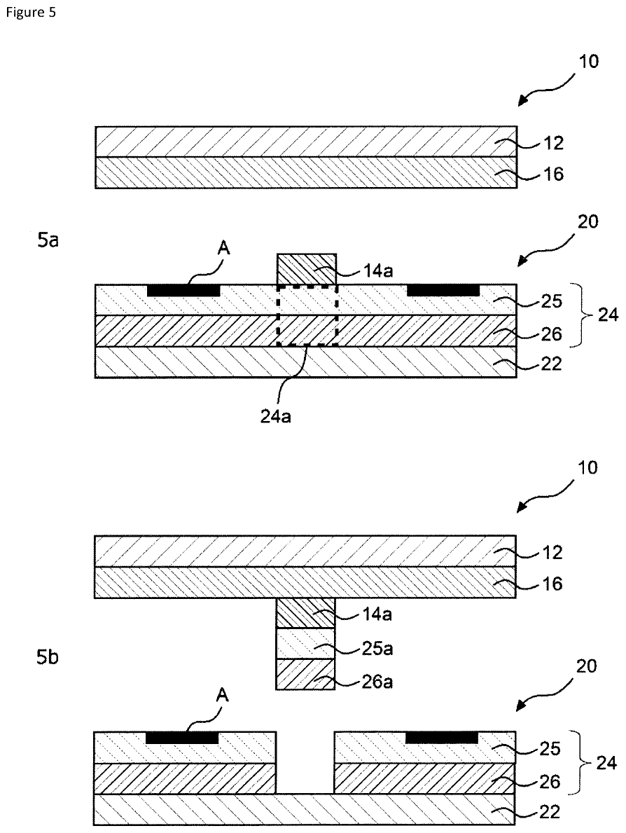

FIGS. 4 to 6 are process cross-sectional views of an embodiment of a method for producing a printed material according to the present disclosure. FIGS. 4 and 5 are process cross-sectional views of an embodiment of a method for peeling off a transfer layer according to the present disclosure.

In FIG. 4a, a first thermal transfer sheet 10 includes a first substrate 12, and a first transfer layer 14, such as a metal-pigment-containing layer, and a peel-off layer 16 provided on one surface of the first substrate 12 in a frame sequential manner. The intermediate transfer medium 20 includes the support 22 and the third transfer layer 24 provided on the support 22. The third transfer layer 24 includes the receiving layer 25 on which a thermal transfer image A is formed, and the separation layer 26.

In FIG. 4b, the first transfer layer 14 of the first thermal transfer sheet 10 is placed opposite the third transfer layer 24 of the intermediate transfer medium 20, thermal energy is applied to the back side of the thermal transfer sheet 10, and a first transfer layer 14a corresponding to the region to which the thermal energy is applied is transferred onto at least a portion of a region to be removed 24a of the third transfer layer 24.

In the embodiment illustrated in FIG. 4b, the first transfer layer 14a is transferred onto the third transfer layer 24 of the intermediate transfer medium 20 so as to overlap the entire region of the region to be removed 24a of the third transfer layer 24 in the thickness direction and so as not to protrude outward from the region to be removed 24a when the intermediate transfer medium 20 is viewed from the top. The phrase “viewed from the top” means that the intermediate transfer medium 20 is viewed in the direction normal to the surface of the intermediate transfer medium 20. FIG. 4c illustrates the intermediate transfer medium 20 viewed from the top. In FIG. 4c, to make it easy to see the region to be removed 24a and the transferred first transfer layer 14a, for convenience, the transferred first transfer layer 14a is illustrated to be slightly smaller than the region to be removed 24a. As described later, the outer edge of the region to be removed 24a preferably coincides with the outer edge of the first transfer layer 14a.

The first transfer layer or the second transfer layer only needs to be transferred onto at least a portion of the region to be removed of the third transfer layer. For example, the first transfer layer or the second transfer layer may be transferred onto the entire surface of the third transfer layer, the first transfer layer or the second transfer layer may be transferred onto the entire region to be removed of the third transfer layer in the same size as the region to be removed, or the first transfer layer or the second transfer layer may be transferred so as to have an area larger or smaller than the area of the region to be removed when viewed from the top.

As the transfer pattern of the first transfer layer or the second transfer layer, for example, when the intermediate transfer medium is viewed from the top, the first transfer layer or the second transfer layer may be transferred in the form of one or more dots, the first transfer layer or the second transfer layer may be transferred in the form of one or more lines, the first transfer layer or the second transfer layer may be transferred onto the third transfer layer in the form of a frame along the outer periphery of the region to be removed of the third transfer layer, or these transfer patterns may be combined.

The first transfer layer or the second transfer layer may be transferred onto the third transfer layer such that the transferred first transfer layer or second transfer layer overlaps the entire region to be removed and such that the outer edge of the region to be removed coincides with the outer edge of the transferred first transfer layer or second transfer layer when the intermediate transfer medium is viewed from the top on the transfer layer side. In this case, when viewed from the top, the region to be removed of the third transfer layer and the transferred first transfer layer or second transfer layer have the same shape.

When viewed from the top, there is no particular limitation on the percentage of the area where the region to be removed of the third transfer layer and the transferred first transfer layer or second transfer layer are superimposed in the thickness direction. Regardless of the percentage, even if a difference in the level is caused by the transfer of the first transfer layer or the second transfer layer, the peel-off layer can improve the peel-off property at the time of removing the region to be removed of the third transfer layer.

A larger area percentage tends to result in a better peel-off property. When the area of the region to be removed of the third transfer layer viewed from the top is defined as 100%, the percentage of the area where the region to be removed of the third transfer layer and the transferred first transfer layer or second transfer layer are superimposed in the thickness direction is preferably 10% or more, more preferably 50% or more, still more preferably 90% or more.

The first transfer layer or the second transfer layer may be transferred onto the third transfer layer such that the transferred first transfer layer or second transfer layer overlaps part or all of the region to be removed of the third transfer layer and protrudes outward from the region to be removed when viewed from the top. Thus, for example, a metal-pigment-containing layer as the first transfer layer or the second transfer layer can be left in a final printed material. The remaining metal-pigment-containing layer can enhance the design performance of a printed material. The metal-pigment-containing layer contains a metal-based pigment, and the metal-pigment-containing layer remaining in the printed material can therefore impart high design performance to the printed material.

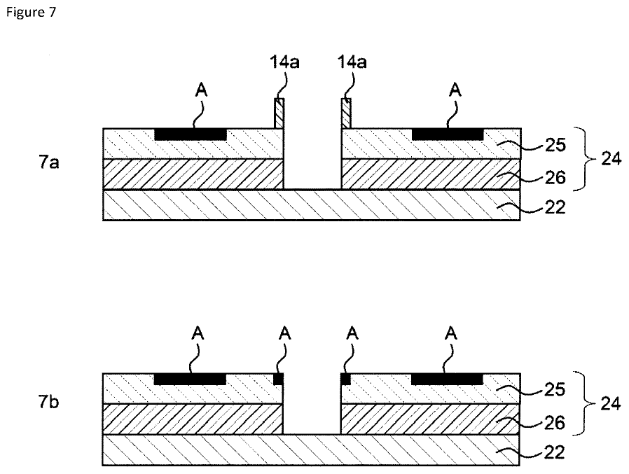

The first transfer layer or the second transfer layer may be transferred onto the third transfer layer such that the transferred first transfer layer or second transfer layer overlaps the entire region to be removed of the third transfer layer and protrudes outward from the entire periphery of the region to be removed when viewed from the top (see FIG. 4d). In this case, after the removal of the region to be removed of the third transfer layer, a frame-shaped first transfer layer or second transfer layer remains along the periphery of the region to be removed (see FIG. 7a). For example, when the region to be removed corresponds to a signature portion of a transfer target, the frame-shaped first transfer layer or second transfer layer transferred to the transfer target can highlight the signature portion.

The first transfer layer or the second transfer layer may be transferred onto the region to be removed of the third transfer layer, and the first transfer layer or the second transfer layer may be transferred onto a region different from the region to be removed in the third transfer layer to form a predetermined image. The first transfer layer or the second transfer layer may have a function of improving the peel-off property and a function of forming a predetermined image, for example, as in the case of a metal-pigment-containing layer. In the primary transfer step, the transfer of a metal-pigment-containing layer onto the region to be removed and the formation of a predetermined image by the metal-pigment-containing layer can be simultaneously performed. This can enhance the design performance of a printed material.

### <<Transfer Layer Removing Step>>

The transfer layer removing step is performed, for example, as described below. The first thermal transfer sheet or the peel-off layer of the peel-off sheet is placed opposite the third transfer layer of the intermediate transfer medium to which the first transfer layer or the second transfer layer is transferred. Thermal energy is applied with a heating member, such as a thermal head, to a region corresponding to the region to be removed on the back side of the first thermal transfer sheet or the peel-off sheet, and the region to be removed of the third transfer layer is removed by the peel-off layer together with the first transfer layer or the second transfer layer transferred in the primary transfer step. Thus, the region to be removed of the third transfer layer of the intermediate transfer medium can be accurately removed.

In this step, for example, the peel-off layer and the region to be removed of the third transfer layer are subjected to thermocompression bonding at least partially via the first transfer layer or the second transfer layer, thereby bringing the third transfer layer into close contact with the peel-off layer at least partially via the first transfer layer or the second transfer layer and removing them. In this step, the thermal compression bonding between the peel-off layer and the third transfer layer at least partially via the first transfer layer or the second transfer layer is preferably performed over the entire region to be removed. Thus, the third transfer layer in the region to be removed can be more accurately removed.

In FIG. 5a, a peel-off layer 16 of a first thermal transfer sheet 10 is placed opposite a third transfer layer 24 of an intermediate transfer medium 20. In FIG. 5b, thermal energy is applied to a region corresponding to a region to be removed 24a on the back side of the first thermal transfer sheet 10. Thus, the region to be removed 24a of the third transfer layer 24 (a separation layer 26a and a receiving layer 25a) is removed by the peel-off layer 16 together with a first transfer layer 14a, such as a metal-pigment-containing layer, transferred in the primary transfer step.

In FIG. 5, the third transfer layer 24 is removed so as to avoid a thermal transfer image A formed on the receiving layer 25. When viewed from the top, the region where the thermal transfer image A is formed and the region to be removed of the third transfer layer may be partially superimposed. In other words, the thermal transfer image A may be partially removed by the peel-off layer (see FIG. 7b).

### (Step (3) (Secondary Transfer Step))

In the step (3), the third transfer layer a portion of which is removed in the step (2) is transferred onto a transfer target (a secondary transfer step). In the step (3), for example, the transfer target and the intermediate transfer medium from which a portion of the third transfer layer is removed are superimposed, that is, the transfer target is placed opposite the third transfer layer of the intermediate transfer medium, and the third transfer layer of the intermediate transfer medium is transferred onto the transfer target.

The transfer target can be appropriately selected and used according to the intended use, and can be, for example, a card substrate, a paper substrate, or the resin substrate described above. The paper substrate is, for example, high-quality paper, art paper, coated paper, resin-coated paper, cast-coated paper, paperboard, synthetic paper, or impregnated paper.

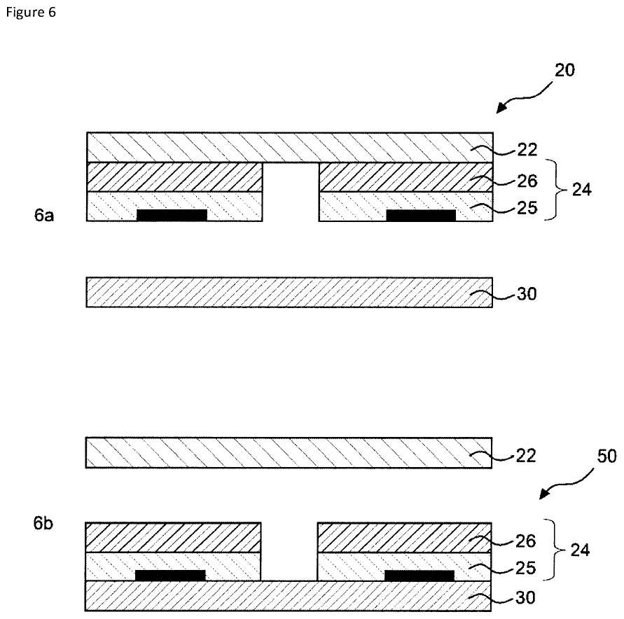

For example, as illustrated in FIGS. 6a and 6b, a third transfer layer 24 a portion of which is removed is transferred from an intermediate transfer medium 20 onto a transfer target 30. Thus, a printed material 50 is produced.

### [Printing Apparatus, Peel-Off Apparatus, and Thermal Transfer Printer]

As a specific example of a printing apparatus used in a method for producing a printed material according to the present disclosure and a peel-off apparatus used in a method for peeling off a transfer layer according to the present disclosure, a thermal transfer printer as a printing apparatus is described below by way of example.

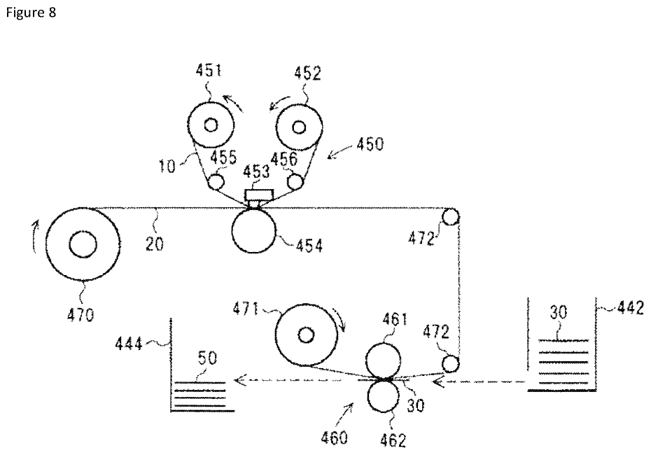

In one embodiment, as illustrated in FIG. 8, the printing apparatus includes a first supply unit 470 for supplying an intermediate transfer medium 20 having a third transfer layer provided on one surface of a support, a second supply unit 451 for supplying a thermal transfer sheet 10 having a first transfer layer and a peel-off layer provided on the same surface of a substrate, a printing unit 450 for heating the thermal transfer sheet 10, transferring the first transfer layer onto at least a portion of a region to be removed of the third transfer layer, and, after the transfer of the first transfer layer, removing the region to be removed of the third transfer layer by the peel-off layer, a third supply unit 442 for supplying a transfer target 30, and a transfer unit 460 for transferring the third transfer layer from which the region to be removed is removed onto the transfer target 30. FIG. 8 is a schematic view of an example of a thermal transfer printer as a printing apparatus.

In one embodiment, the peel-off apparatus includes the first supply unit, the second supply unit, and a peel-off unit with the same structure as the printing unit, each of which is described above.

Instead of the above embodiment, in another embodiment, the second supply unit of the printing apparatus may include a 2-1 supply unit for supplying a thermal transfer sheet having a second transfer layer provided on a surface of a substrate and a 2-2 supply unit for supplying a peel-off sheet having a peel-off layer provided on a surface of a substrate. In another embodiment, the printing unit of the printing apparatus may be a printing unit for heating a thermal transfer sheet, transferring a second transfer layer onto at least a portion of a region to be removed of a third transfer layer, and, after the transfer of the second transfer layer, removing the region to be removed of the third transfer layer by a peel-off layer.

In another embodiment, the peel-off apparatus includes the first supply unit, the 2-1 supply unit, the 2-2 supply unit, and a peel-off unit with the same structure as the printing unit of the other embodiment described above, each of which is described above.

The embodiment illustrated in FIG. 8 is described in detail below. Other embodiments can also be implemented in the same manner by providing the 2-1 supply unit and the 2-2 supply unit instead of the second supply unit.

The first supply unit 470 is loaded with a roll of the intermediate transfer medium 20 wound in a ribbon shape. The first supply unit 470 rotates the roll of the intermediate transfer medium 20 and transports the intermediate transfer medium 20 in a long belt shape to the printing unit 450 and the transfer unit 460.

The printing unit 450 includes a thermal head 453, a rotatably drivable platen roller 454 provided below the thermal head 453, and a raising and lowering means (not shown) for raising and lowering the thermal head 453 with respect to the platen roller 454. The intermediate transfer medium 20 supplied from the first supply unit 470 passes between the thermal head 453 and the platen roller 454.

The thermal transfer sheet 10 passes between the thermal head 453 and the platen roller 454 from a supply roller as the second supply unit 451 via a guide roller 455 and is taken up by a take-up roller 452 via a guide roller 456. The first transfer layer and the peel-off layer of the thermal transfer sheet 10 are opposed to the third transfer layer of the intermediate transfer medium 20 between the thermal head 453 and the platen roller 454 (not shown).

The thermal head 453 heats the first transfer layer of the thermal transfer sheet 10 and transfers the first transfer layer corresponding to the region to be removed onto the third transfer layer. In the thermal transfer printer, after the intermediate transfer medium 20 and the first transfer layer of the thermal transfer sheet 10 are aligned, the thermal head 453 is lowered toward the platen roller 454, and the thermal head 453 is brought into contact with the platen roller 454 with the thermal transfer sheet 10 and the intermediate transfer medium 20 interposed therebetween. The platen roller 454 is rotationally driven to transport the thermal transfer sheet 10 and the intermediate transfer medium 20 to the downstream side. During this time, the thermal head 453 selectively heats the first transfer layer of the thermal transfer sheet 10 on the basis of the data transmitted to the thermal head 453. Thus, the first transfer layer is transferred onto at least a portion of the region to be removed of the third transfer layer.

When the first transfer layer, such as a metal-pigment-containing layer, is also used to form a thermal transfer image, combined data obtained by combining image pattern data of the thermal transfer image and transfer pattern data of the first transfer layer to be transferred onto a region to be removed may be transmitted to the thermal head 453 to transfer the first transfer layer onto the region to be removed and simultaneously form the thermal transfer image.

The thermal head 453 heats the peel-off layer of the thermal transfer sheet 10 and removes the region to be removed of the third transfer layer together with the previously transferred first transfer layer. After the first transfer layer is transferred, the thermal transfer printer raises the thermal head 453 and aligns the intermediate transfer medium 20 with the peel-off layer of the thermal transfer sheet 10. The thermal head 453 is then lowered toward the platen roller 454 to come into contact with the platen roller 454 with the thermal transfer sheet 10 and the intermediate transfer medium 20 interposed therebetween. The platen roller 454 is then rotationally driven to transport the thermal transfer sheet 10 and the intermediate transfer medium 20 to the downstream side. During this time, the thermal head 453 selectively heats the peel-off layer of the thermal transfer sheet 10 on the basis of data of the region to be removed transmitted to the thermal head 453. Thus, the region to be removed of the third transfer layer is removed together with the previously transferred first transfer layer.

The thermal transfer printer transports the intermediate transfer medium 20 from which the region to be removed of the third transfer layer is removed to the transfer unit 460 via a guide roller 472. The transfer unit 460 includes a heating roller 461 and a pressure roller 462 provided below the heating roller 461. The transfer unit 460 transfers the third transfer layer from which the region to be removed is removed to the transfer target 30 supplied from the third supply unit 442.

The third supply unit 442 includes a feeder for feeding the transfer target 30 in a sheet form one by one in response to the transport of the intermediate transfer medium 20, a conveyor device for transporting the fed transfer target 30, and the like. The transfer target 30 may be a long roll.

The transfer unit 460 heats the surface of the third transfer layer of the intermediate transfer medium 20 superimposed on the transfer target 30 between the heating roller 461 and the pressure roller 462. Thus, a printed material 50 is produced in which the third transfer layer from which the region to be removed is removed is transferred onto the transfer target 30.

The printed material 50 is transported to a discharge unit 444 and is stacked one by one. The intermediate transfer medium 20 from which the third transfer layer is transferred is taken up by a take-up roller 471.

The thermal transfer printer according to one embodiment described above can accurately remove the region to be removed of the third transfer layer and can transfer the third transfer layer from which the region to be removed is accurately removed onto a transfer target.

A thermal transfer printer according to one embodiment aligns the intermediate transfer medium 20 with a coloring material layer of the thermal transfer sheet 10, lowers the thermal head 453 toward the platen roller 454, and brings the thermal head 453 into contact with the platen roller 454 with the thermal transfer sheet 10 and the intermediate transfer medium 20 interposed therebetween. The platen roller 454 is then rotationally driven to transport the thermal transfer sheet 10 and the intermediate transfer medium 20 to the downstream side. During this time, the thermal head 453 selectively heats a region of the coloring material layer of the thermal transfer sheet 10 on the basis of image data transmitted to the thermal head 453 to transfer a coloring material of the coloring material layer from the thermal transfer sheet 10 to a receiving layer constituting the third transfer layer. Thus, a thermal transfer image can be formed on the third transfer layer.

The present disclosure relates to, for example, the following [1] to [17]:

[1] A thermal transfer sheet including: a first substrate; and a first transfer layer and a peel-off layer provided on one surface of the first substrate in a frame sequential manner, wherein the first transfer layer after transfer under the following condition (A) has an arithmetic mean height Sa of more than 0.1 μm and less than 0.6 μm, and the peel-off layer has an arithmetic mean height Sa of more than 0.1 μm and less than 1.0 μm,
[Condition (A)]
an intermediate transfer medium including a receiving layer having a surface with an arithmetic mean height Sa of 0.1 μm is prepared, and the first transfer layer of the thermal transfer sheet is placed opposite the receiving layer of the intermediate transfer medium, and an application energy of 0.167 mJ/dot is applied to transfer the first transfer layer of the thermal transfer sheet to a surface of the receiving layer of the intermediate transfer medium.

[2] The thermal transfer sheet according to [1], wherein the peel-off layer contains a particle.

[3] The thermal transfer sheet according to [1] or [2], wherein the first transfer layer after transfer under the condition (A) has an arithmetic mean height Sa of more than 0.1 μm and less than 0.5 μm.

[4] The thermal transfer sheet according to any one of [1] to [3], wherein the first transfer layer contains a metal-based pigment and a binder.

[5] The thermal transfer sheet according to [4], wherein the metal-based pigment is at least one selected from a metal pigment, a metal oxide pigment, and a coated pigment.

[6] A combination of a thermal transfer sheet and a peel-off sheet, wherein the thermal transfer sheet includes a second substrate and a second transfer layer provided on one surface of the second substrate, the second transfer layer after transfer under the following condition (A) has an arithmetic mean height Sa of more than 0.1 μm and less than 0.6 μm, the peel-off sheet includes a third substrate and a peel-off layer provided on one surface of the third substrate, and the peel-off layer has an arithmetic mean height Sa of more than 0.1 μm and less than 1.0 μm,
[Condition (A)]
an intermediate transfer medium including a receiving layer having a surface with an arithmetic mean height Sa of 0.1 μm is prepared, and the second transfer layer of the thermal transfer sheet is placed opposite the receiving layer of the intermediate transfer medium, and an application energy of 0.167 mJ/dot is applied to transfer the second transfer layer of the thermal transfer sheet to a surface of the receiving layer of the intermediate transfer medium.

[7] The combination according to [6], wherein the peel-off layer contains a particle.

[8] The combination according to [6] or [7], wherein the second transfer layer after transfer under the condition (A) has an arithmetic mean height Sa of more than 0.1 μm and less than 0.5 μm.

[9] The combination according to any one of [6] to [8], wherein the second transfer layer contains a metal-based pigment and a binder.

[10] The combination according to [9], wherein the metal-based pigment is at least one selected from a metal pigment, a metal oxide pigment, and a coated pigment.

[11] A method for producing a printed material, including the steps of: (1) preparing at least a thermal transfer sheet and an intermediate transfer medium including a third transfer layer; (2) removing a portion of the third transfer layer; and (3) transferring the third transfer layer a portion of which is removed onto a transfer target, wherein the step (1) includes preparing the thermal transfer sheet according to any one of [1] to [5] as a first thermal transfer sheet and the intermediate transfer medium, or preparing the combination of the thermal transfer sheet and the peel-off sheet according to any one of [6] to [10] as a combination of a second thermal transfer sheet and a peel-off sheet, and the intermediate transfer medium, wherein the intermediate transfer medium includes a support and the third transfer layer provided on one surface of the support so as to be separable from the support, and a portion of the third transfer layer is a region to be removed in the step (2), and the step (2) includes transferring the first transfer layer or the second transfer layer from the first thermal transfer sheet or the second thermal transfer sheet onto at least a portion of the region to be removed of the third transfer layer in the intermediate transfer medium, and removing, by the first thermal transfer sheet or the peel-off layer of the peel-off sheet, the region to be removed of the third transfer layer together with the first transfer layer or the second transfer layer transferred onto the region to be removed, in this order.

[12] The method for producing a printed material according to [11], wherein the third transfer layer in the intermediate transfer medium includes a receiving layer, and the method further includes forming a thermal transfer image on the receiving layer before the step (2).

[13] The method for producing a printed material according to [12], wherein the first thermal transfer sheet includes a coloring material layer, the first transfer layer, and the peel-off layer provided on one surface of the first substrate in a frame sequential manner, and the coloring material layer of the first thermal transfer sheet is used to form the thermal transfer image.

[14] The method for producing a printed material according to [12], wherein the second thermal transfer sheet includes a coloring material layer and the second transfer layer provided on one surface of the second substrate in a frame sequential manner, and the coloring material layer of the second thermal transfer sheet is used to form the thermal transfer image.

[15] A method for peeling off a transfer layer, including the steps of: (1) preparing at least a thermal transfer sheet and an intermediate transfer medium including a third transfer layer; and (2) removing a portion of the third transfer layer, wherein the step (1) includes preparing the thermal transfer sheet according to any one of [1] to [5] as a first thermal transfer sheet and the intermediate transfer medium, or preparing the combination of the thermal transfer sheet and the peel-off sheet according to any one of [6] to [10] as a combination of a second thermal transfer sheet and a peel-off sheet, and the intermediate transfer medium, wherein the intermediate transfer medium includes a support and the third transfer layer provided on one surface of the support so as to be separable from the support, and a portion of the third transfer layer is a region to be removed in the step (2), and the step (2) includes transferring the first transfer layer or the second transfer layer from the first thermal transfer sheet or the second thermal transfer sheet onto at least a portion of the region to be removed of the third transfer layer in the intermediate transfer medium, and removing, by the first thermal transfer sheet or the peel-off layer of the peel-off sheet, the region to be removed of the third transfer layer together with the first transfer layer or the second transfer layer transferred onto the region to be removed, in this order.

[16] A printing apparatus including: a first supply unit for supplying an intermediate transfer medium including a support and a third transfer layer provided on one surface of the support so as to be separable from the support; a second supply unit for supplying the thermal transfer sheet according to any one of [1] to [5] or the combination of the thermal transfer sheet and the peel-off sheet according to any one of [6] to [10]; a printing unit for heating the thermal transfer sheet, transferring the first transfer layer or the second transfer layer of the thermal transfer sheet onto at least a portion of a region to be removed of the third transfer layer, and removing the region to be removed of the third transfer layer by the thermal transfer sheet or the peel-off layer of the peel-off sheet after the transfer of the first transfer layer or the second transfer layer; a third supply unit for supplying a transfer target; and a transfer unit for transferring the third transfer layer from which the region to be removed in the intermediate transfer medium is removed onto the transfer target.

[17] A peel-off apparatus including: a first supply unit for supplying an intermediate transfer medium including a support and a third transfer layer provided on one surface of the support so as to be separable from the support; a second supply unit for supplying the thermal transfer sheet according to any one of [1] to [5] or the combination of the thermal transfer sheet and the peel-off sheet according to any one of [6] to [10]; and a peel-off unit for heating the thermal transfer sheet, transferring the first transfer layer or the second transfer layer of the thermal transfer sheet onto at least a portion of a region to be removed of the third transfer layer, and removing the region to be removed of the third transfer layer by the thermal transfer sheet or the peel-off layer of the peel-off sheet after the transfer of the first transfer layer or the second transfer layer.

### EXAMPLES

Although the present disclosure is further described in the following examples, the present disclosure is not limited to these examples. Unless otherwise specified, “parts” is based on mass. “Parts” is the mass based on the solid content (excluding solvent).

### Example 1: Preparation of Thermal Transfer Sheet (1)

A poly(ethylene terephthalate) film with a thickness of 6 μm was used as a first substrate. A coating liquid for a release layer with the following composition was applied to one surface of the first substrate and was dried to form a release layer with a thickness of 0.2 μm. A coating liquid (1) for a metal-pigment-containing layer with the following composition was applied to the release layer and was dried to form a metal-pigment-containing layer with a thickness of 0.7 μm. A coating liquid (1) for a peel-off layer with the following composition was applied to the same surface of the first substrate in a frame sequential manner with respect to the metal-pigment-containing layer and was dried to form a peel-off layer with a thickness of 1 μm. A coating liquid for a back layer with the following composition was applied to the other surface of the first substrate and was dried to form a back layer with a thickness of 0.8 μm. A thermal transfer sheet (1) was produced in this manner. The arithmetic mean height Sa of the peel-off layer was measured.

### <Coating Liquid for Release Layer>

Urethane resin 25 parts
Poly(vinyl acetal) 75 parts (S-Lec™ KS-5, Sekisui Chemical Co., Ltd.)
Toluene 950 parts
Isopropyl alcohol 950 parts

### <Coating Liquid (1) for Metal-Pigment-Containing Layer>

Aluminum pigment (A1 pigment) 20 parts (FD-5060, average particle size: 6 μm, hiding power: 3.4, non-leafing type, Asahi Kasei Corporation)
Vinyl chloride-vinyl acetate copolymer 40 parts (Solbin™ CNL, Nissin Chemical Industry Co., Ltd.)
Methyl ethyl ketone (MEK) 30 parts
Toluene 30 parts

### <Coating Liquid (1) for Peel-Off Layer>

Vinyl chloride-vinyl acetate copolymer 10 parts (Solbin™ C5R, Nissin Chemical Industry Co., Ltd.)
(Meth)acrylic resin 10 parts (Dianal™ BR-83, Mitsubishi Rayon Co., Ltd.)
Organic particles A (melamine-formaldehyde condensate) 2 parts (Epostar™ S6, average particle size: 0.4 μm, Nippon Shokubai Co., Ltd.)
MEK 80 parts

### <Coating Liquid for Back Layer>

Poly(vinyl butyral) 2 parts (S-Lec™ BX-1, Sekisui Chemical Co., Ltd.)
Polyisocyanate 9.2 parts (Burnock™ D750, DIC Corporation)
Phosphate surfactant 1.3 parts (Plysurf™ A208N, Dai-ichi Kogyo Seiyaku Co., Ltd.)
Talc 0.3 parts (Micro Ace™ P-3, Nippon Talc Co., Ltd.)
Toluene 43.6 parts
MEK 43.6 parts

### Examples 2 to 10, Comparative Example 2: Preparation of Thermal Transfer Sheets (2) to (10) and (c2)

Thermal transfer sheets (2) to (10) and (c2) were produced in the same manner as in Example 1 except that a coating liquid shown in Table 1 was used in place of the coating liquid (1) for a metal-pigment-containing layer to form a metal-pigment-containing layer and/or a coating liquid shown in Table 1 was used in place of the coating liquid (1) for a peel-off layer to form a peel-off layer.

### Comparative Example 1: Preparation of Thermal Transfer Sheet (c1)

A thermal transfer sheet (c1) was produced in the same manner as in Example 1 except that the metal-pigment-containing layer was not formed and a coating liquid (5) was used in place of the coating liquid (1) for a peel-off layer to form a peel-off layer.

### <Coating Liquid (2) for Metal-Pigment-Containing Layer>

A1 pigment described above 20 parts
Vinyl chloride-vinyl acetate copolymer 20 parts (Solbin™ CNL, Nissin Chemical Industry Co., Ltd.)
MEK 30 parts
Toluene 30 parts

### <Coating Liquid (3) for Metal-Pigment-Containing Layer>

Coated pigment A 15 parts (Metashine™ 2025PS, core material: glass, coating material: silver, average particle size: 25 μm, Nippon Sheet Glass Co., Ltd.)
Vinyl chloride-vinyl acetate copolymer 30 parts (Solbin™ CNL, Nissin Chemical Industry Co., Ltd.)
MEK 35 parts
Toluene 35 parts

### <Coating Liquid (4) for Metal-Pigment-Containing Layer>

Coated pigment A 15 parts
Vinyl chloride-vinyl acetate copolymer 15 parts (Solbin™ CNL, Nissin Chemical Industry Co., Ltd.)
MEK 35 parts
Toluene 35 parts

### <Coating Liquid (5) for Metal-Pigment-Containing Layer>

Coated pigment B 15 parts (Iriodin™ 111WNT, average particle size: 7 μm, pearl pigment, Merck & Co., Inc.)
Vinyl chloride-vinyl acetate copolymer 15 parts (Solbin™ CNL, Nissin Chemical Industry Co., Ltd.)
MEK 35 parts
Toluene 35 parts

### <Coating Liquid (6) for Metal-Pigment-Containing Layer>

A1 pigment described above 40 parts
Vinyl chloride-vinyl acetate copolymer 20 parts (Solbin™ CNL, Nissin Chemical Industry Co., Ltd.)
MEK 30 parts
Toluene 30 parts

### <Coating Liquid (7) for Metal-Pigment-Containing Layer>

Coated pigment A 30 parts
Vinyl chloride-vinyl acetate copolymer 15 parts (Solbin™ CNL, Nissin Chemical Industry Co., Ltd.)
MEK 35 parts
Toluene 35 parts

### <Coating Liquid (2) for Peel-Off Layer>

Vinyl chloride-vinyl acetate copolymer 10 parts (Solbin™ C5R, Nissin Chemical Industry Co., Ltd.)
(Meth)acrylic resin 10 parts (Dianal™ BR-83, Mitsubishi Rayon Co., Ltd.)
Organic particles A 4 parts
MEK 80 parts

### <Coating Liquid (3) for Peel-Off Layer>

Vinyl chloride-vinyl acetate copolymer 10 parts (Solbin™ C5R, Nissin Chemical Industry Co., Ltd.)
(Meth)acrylic resin 10 parts (Dianal™ BR-83, Mitsubishi Rayon Co., Ltd.)
Organic particles B (melamine-formaldehyde condensate) 2 parts (Epostar™ S12, average particle size: 1.2 μm, Nippon Shokubai Co., Ltd.)
MEK 80 parts

### <Coating Liquid (4) for Peel-Off Layer>

Vinyl chloride-vinyl acetate copolymer 10 parts (Solbin™ C5R, Nissin Chemical Industry Co., Ltd.)
(Meth)acrylic resin 10 parts (Dianal™ BR-83, Mitsubishi Rayon Co., Ltd.)
Inorganic particles C 2 parts (Sylysia™ 310P, average particle size: 2.7 μm, Fuji Silysia Chemical Ltd.)
MEK 80 parts

### <Coating Liquid (5) for Peel-Off Layer>

Vinyl chloride-vinyl acetate copolymer 10 parts (Solbin™ C5R, Nissin Chemical Industry Co., Ltd.)
(Meth)acrylic resin 10 parts (Dianal™ BR-83, Mitsubishi Rayon Co., Ltd.)
MEK 80 parts

### [Preparation of Intermediate Transfer Medium (1)]

A poly(ethylene terephthalate) film with a thickness of 16 μm was used as a support. A coating liquid for a separation layer with the following composition was applied to the support and was dried to form a separation layer with a thickness of 1 μm. A coating liquid for a protective layer with the following composition was applied to the separation layer and was dried to form a protective layer with a thickness of 2 μm. A coating liquid for a receiving layer with the following composition was applied to the protective layer and was dried to form a receiving layer with a thickness of 1.5 μm. An intermediate transfer medium (1) thus produced included the support, the separation layer, the protective layer, and the receiving layer in this order in the thickness direction. The separation layer, the protective layer, and the receiving layer constitute a third transfer layer. The receiving layer had an arithmetic mean height Sa of 0.1 μm.

### <Coating Liquid for Separation Layer>

(Meth)acrylic resin 29 parts (Dianal™ BR-87, Mitsubishi Rayon Co., Ltd.)
Polyester 1 part (Vylon™ 200, Toyobo Co., Ltd.)
MEK 35 parts
Toluene 35 parts

### <Coating Liquid for Protective Layer>

Polyester 30 parts (Vylon™ 200, Toyobo Co., Ltd.)
MEK 35 parts
Toluene 35 parts

### <Coating Liquid for Receiving Layer>

Vinyl chloride-vinyl acetate copolymer 20 parts (Solbin™ CNL, Nissin Chemical Industry Co., Ltd.)
Silicone oil 1 part (X-22-3000T, Shin-Etsu Chemical Co., Ltd.)
MEK 79 parts

### [Measurement of Arithmetic Mean Height Sa]

A shape analysis laser microscope (manufactured by Keyence Corporation, trade name: VK-X150) was used to measure the arithmetic mean height Sa on the surfaces of the peel-off layer and the metal-pigment-containing layer in the measurement range of 675 μm×506 μm in accordance with ISO 25178. More specifically, nine images of 3 images×3 images in the vertical and horizontal directions each having a size of 270 μm×200 am were combined, and a range of 675 μm×506 μm was cut out from the combined image and was used for analysis. The magnification of an objective lens was 50 times, and the image was entirely subjected to tilt correction before analysis.

### [Production of Printed Material]

The metal-pigment-containing layer of the thermal transfer sheet produced in Examples 1 to 10 or Comparative Example 2 was placed opposite the receiving layer of the intermediate transfer medium (1), and the following printer was used to primarily transfer the metal-pigment-containing layer of the thermal transfer sheet onto the entire surface of the receiving layer of the intermediate transfer medium (1) at an energy of 255/255 gray scale, more specifically, an application energy of 0.167 mJ/dot.

At this time, the arithmetic mean height Sa of the transferred metal-pigment-containing layer was measured. The peel-off layer of the thermal transfer sheet was then placed opposite the receiving layer of the intermediate transfer medium (1) to which the metal-pigment-containing layer was transferred, and the following printer was used to remove a region to be removed of the third transfer layer together with the transferred metal-pigment-containing layer at an energy of 255/255 gray scale.

The peel-off layer of the thermal transfer sheet produced in Comparative Example 1 was placed opposite the receiving layer of the intermediate transfer medium (1), and the following printer was used to remove a region to be removed of the third transfer layer at an energy of 255/255 gray scale.

### (Printer)

Thermal head: KEE-57-12GAN2-STA (manufactured by Kyocera Corporation)
Average resistance of heating element: 3303 (Q)
Print density in main scanning direction: 300 (dpi)
Print density in sub-scanning direction: 300 (dpi)
One line cycle: 2.0 (ms)
Printing start temperature: 35 (° C.)
Pulse duty ratio: 85%
Applied voltage: 18 (V)

The intermediate transfer medium (1) with a partially removed third transfer layer, a poly(vinyl chloride) (PVC) card, and a laminator (Lamipacker LPD3212 manufactured by Fujipla) were prepared. The third transfer layer of the intermediate transfer medium (1) and the metal-pigment-containing layer primarily transferred onto the transfer layer were secondarily transferred onto the PVC card at a temperature of 175° C. and at a speed of 40 mm/s to produce a printed material. For Comparative Example 1, the third transfer layer of the intermediate transfer medium (1) was secondarily transferred onto the PVC card to produce a printed material.

### [Evaluation of Peel-Off Property]

The intermediate transfer medium from which the region to be removed of the third transfer layer was removed was visually observed, and the peel-off property was evaluated on the basis of the following evaluation criteria. Table 1 shows the results.

### (Evaluation Criteria)

5: The region to be removed of the third transfer layer is accurately removed, and there is no looseness of the boundary line or no fine residue in the region to be removed.
4: The region to be removed of the third transfer layer is accurately removed, and there is little looseness of the boundary line and a slight fine residue in the region to be removed.
3: Although the region to be removed of the third transfer layer is accurately removed, there is a little looseness of the boundary line or a fine residue in the region to be removed.
2: Although the region to be removed of the third transfer layer is partially inaccurately removed, it is allowable in actual operation.
1: The region to be removed of the third transfer layer is not accurately removed (NG).

### [Evaluation of Design Performance]

The resulting printed material was visually observed and was evaluated on the basis of the following evaluation criteria. Table 1 shows the results.

### (Evaluation Criteria)

5: 5: The printed material had high gloss, brilliancy, or pearliness.
3: The printed material had low gloss, brilliancy, or pearliness.
1: The printed material had no gloss, brilliancy, or pearliness.

TABLE 1

| | | Example 1 | Example 2 | Example 3 | Example 4 | Example 5 | Example 6 | Example 7 |
|---|---|---|---|---|---|---|---|---|
| Thermal transfer sheet | | (1) | (2) | (3) | (4) | (5) | (6) | (7) |
| Peel-off layer | Coating liquid for peel-off layer | (1) | (1) | (1) | (1) | (1) | (2) | (3) |
| | Particles type | Organic | Organic | Organic | Organic | Organic | Organic | Organic |
| | | particles A | particles A | particles A | particles A | particles A | particles A | particles B |
| | Particles average particle size(um) | 0.4 | 0.4 | 0.4 | 0.4 | 0.4 | 0.4 | 1.2 |
| | PV ratio | 0.1 | 0.1 | 0.1 | 0.1 | 0.1 | 0.2 | 0.1 |
| | Arithmetic mean height Sa(um) | 0.3 | 0.3 | 0.3 | 0.3 | 0.3 | 0.5 | 0.5 |
| Metal-pigment- | Coating liquid for metal-pigment- | (1) | (2) | (3) | (4) | (5) | (1) | (1) |
| containing layer | containing layer | | | | | | | |
| | Metal-based pigment type | Al | Al | Coated | Coated | Coated | Al | Al |
| | | pigment | pigment | pigment A | pigment A | pigment A | pigment | pigment |
| | PV ratio | 0.5 | 1 | 0.5 | 1 | 1 | 0.5 | 0.5 |
| | Arithmetic mean height Sa(um) | 0.3 | 0.4 | 0.3 | 0.4 | 0.4 | 0.3 | 0.3 |
| Rating | Peel-off property | 4 | 5 | 4 | 5 | 5 | 5 | 5 |
| | Design performance | 5 | 5 | 5 | 5 | 5 | 5 | 5 |

| | | | | | Comparative | Comparative |
|---|---|---|---|---|---|---|
| | | Example 8 | Example 9 | Example 10 | example 1 | example 2 |
| Thermal transfer sheet | | (8) | (9) | (10) | (c1) | (c2) |
| Peel-off layer | Coating liquid for peel-off layer | (4) | (1) | (1) | (5) | (5) |
| | Particles type | Inorganic | Organic | Organic | — | — |
| | | particles C | particles A | particles A | | |
| | Particles average particle size(um) | 2.7 | 0.4 | 0.4 | — | — |
| | PV ratio | 0.1 | 0.1 | 0.1 | — | — |
| | Arithmetic mean height Sa(um) | 0.5 | 0.3 | 0.3 | 0.1 | 0.1 |
| Metal-pigment- | Coating liquid for metal-pigment- | (1) | (6) | (7) | — | (1) |
| containing layer | containing layer | | | | | |
| | Metal-based pigment type | Al | Al | Coated | — | Al |
| | | pigment | pigment | pigment A | | pigment |
| | PV ratio | 0.5 | 2 | 2 | — | 0.5 |
| | Arithmetic mean height Sa(um) | 0.3 | 0.5 | 0.5 | — | 0.3 |
| Rating | Peel-off property | 5 | 5 | 5 | 3 | 3 |
| | Design performance | 5 | 3 | 3 | 1 | 5 |

Those skilled in the art will appreciate that a thermal transfer sheet and the like according to the present disclosure are not limited to these examples, the examples and the description only illustrate the principles of the present disclosure, various modifications and improvements may be made without departing from the gist and scope of the present disclosure, and all the modifications and improvements fall within the scope of the present disclosure for which protection is sought. Furthermore, the scope for which protection is sought by the present disclosure includes not only the claims but also equivalents thereof.

### REFERENCE SIGNS LIST

10, 10a thermal transfer sheet, 11 peel-off sheet, 12, 12a, 12b substrate, 14 first transfer layer, 14a portion of first transfer layer, 16 peel-off layer, 18 coloring material layer, 20 intermediate transfer medium, 22 support, 24 third transfer layer, 24a region to be removed of third transfer layer, 25 receiving layer, 25a portion of receiving layer, 26 separation layer, 26a portion of separation layer, 30 transfer target, 50 printed material, A thermal transfer image,
470 first supply unit, 451 second supply unit, 450 printing unit, 442 third supply unit, 460 transfer unit, 453 thermal head, 454 platen roller, 455, 456, 472 guide roller, 452, 471 take-up roller, 461 heating roller, 462 pressure roller, 444 discharge unit

1. A thermal transfer sheet comprising:
a first substrate; and a first transfer layer and a peel-off layer provided on one surface of the first substrate in a frame sequential manner,
wherein the first transfer layer after transfer under the following condition (A) has an arithmetic mean height Sa of more than 0.1 μm and less than 0.6 μm, and the peel-off layer has an arithmetic mean height Sa of more than 0.1 μm and less than 1.0 μm,
[Condition (A)]
an intermediate transfer medium including a receiving layer having a surface with an arithmetic mean height Sa of 0.1 μm is prepared, and the first transfer layer of the thermal transfer sheet is placed opposite the receiving layer of the intermediate transfer medium, and an application energy of 0.167 mJ/dot is applied to transfer the first transfer layer of the thermal transfer sheet to a surface of the receiving layer of the intermediate transfer medium.

2. The thermal transfer sheet according to claim 1, wherein
the peel-off layer contains a particle.

3. The thermal transfer sheet according to claim 1, wherein the first transfer layer after transfer under the condition (A) has an arithmetic mean height Sa of more than 0.1 μm and less than 0.5 μm.

4. The thermal transfer sheet according to claim 1, wherein the first transfer layer contains a metal-based pigment and a binder.

5. The thermal transfer sheet according to claim 4, wherein the metal-based pigment is at least one selected from a metal pigment, a metal oxide pigment, and a coated pigment.

6. A combination of a thermal transfer sheet and a peel-off sheet,
wherein the thermal transfer sheet includes a second substrate and a second transfer layer provided on one surface of the second substrate, the second transfer layer after transfer under the following condition (A) has an arithmetic mean height Sa of more than 0.1 μm and less than 0.6 μm, the peel-off sheet includes a third substrate and a peel-off layer provided on one surface of the third substrate, and the peel-off layer has an arithmetic mean height Sa of more than 0.1 μm and less than 1.0 μm,
[Condition (A)]
an intermediate transfer medium including a receiving layer having a surface with an arithmetic mean height Sa of 0.1 μm is prepared, and the second transfer layer of the thermal transfer sheet is placed opposite the receiving layer of the intermediate transfer medium, and an application energy of 0.167 mJ/dot is applied to transfer the second transfer layer of the thermal transfer sheet to a surface of the receiving layer of the intermediate transfer medium.

7. The combination according to claim 6, wherein the peel-off layer contains a particle.

8. The combination according to claim 6, wherein the second transfer layer after transfer under the condition (A) has an arithmetic mean height Sa of more than 0.1 μm and less than 0.5 μm.

9. The combination according to claim 6, wherein the second transfer layer contains a metal-based pigment and a binder.

10. The combination according to claim 9, wherein the metal-based pigment is at least one selected from a metal pigment, a metal oxide pigment, and a coated pigment.

11. A method for producing a printed material, comprising the steps of:
(1) preparing at least a thermal transfer sheet and an intermediate transfer medium including a third transfer layer;
(2) removing a portion of the third transfer layer; and
(3) transferring the third transfer layer a portion of which is removed onto a transfer target,
wherein the step (1) includes preparing the thermal transfer sheet according to claim 1 as a first thermal transfer sheet and the intermediate transfer medium, or preparing a combination of a thermal transfer sheet and a peel-off sheet as a combination of a second thermal transfer sheet and a peel-off sheet, and the intermediate transfer medium,
the intermediate transfer medium includes a support and the third transfer layer provided on one surface of the support so as to be separable from the support, and a portion of the third transfer layer is a region to be removed in the step (2), and
the step (2) includes, in order,
transferring the first transfer layer or the second transfer layer from the first thermal transfer sheet or the second thermal transfer sheet onto at least a portion of the region to be removed of the third transfer layer in the intermediate transfer medium, and
removing, by the first thermal transfer sheet or the peel-off layer of the peel-off sheet, the region to be removed of the third transfer layer together with the first transfer layer or the second transfer layer transferred onto the region to be removed.

12. The method for producing a printed material according to claim 11, wherein
the third transfer layer in the intermediate transfer medium includes a receiving layer, and the method further comprises forming a thermal transfer image on the receiving layer before the step (2).

13. The method for producing a printed material according to claim 12, wherein the first thermal transfer sheet includes a coloring material layer, the first transfer layer, and the peel-off layer provided on one surface of the first substrate in a frame sequential manner, and the coloring material layer of the first thermal transfer sheet is used to form the thermal transfer image.

14. The method for producing a printed material according to claim 12, wherein the second thermal transfer sheet includes a coloring material layer and the second transfer layer provided on one surface of the second substrate in a frame sequential manner, and the coloring material layer of the second thermal transfer sheet is used to form the thermal transfer image.

15. A method for peeling off a transfer layer, comprising the steps of:
(1) preparing at least a thermal transfer sheet and an intermediate transfer medium including a third transfer layer; and
(2) removing a portion of the third transfer layer,
wherein the step (1) includes preparing the thermal transfer sheet according to claim 1 as a first thermal transfer sheet and the intermediate transfer medium, or preparing a combination of a thermal transfer sheet and a peel-off sheet as a combination of a second thermal transfer sheet and a peel-off sheet, and the intermediate transfer medium,
the intermediate transfer medium includes a support and the third transfer layer provided on one surface of the support so as to be separable from the support, and a portion of the third transfer layer is a region to be removed in the step (2), and
the step (2) includes, in order,
transferring the first transfer layer or the second transfer layer from the first thermal transfer sheet or the second thermal transfer sheet onto at least a portion of the region to be removed of the third transfer layer in the intermediate transfer medium, and
removing, by the first thermal transfer sheet or the peel-off layer of the peel-off sheet, the region to be removed of the third transfer layer together with the first transfer layer or the second transfer layer transferred onto the region to be removed.

16. A printing apparatus comprising:
a first supply unit for supplying an intermediate transfer medium including a support and a third transfer layer provided on one surface of the support so as to be separable from the support;
a second supply unit for supplying the thermal transfer sheet according to claim 1 or a combination of a thermal transfer sheet and a peel-off sheet;
a printing unit for heating the thermal transfer sheet, transferring the first transfer layer or the second transfer layer of the thermal transfer sheet onto at least a portion of a region to be removed of the third transfer layer, and removing the region to be removed of the third transfer layer by the thermal transfer sheet or the peel-off layer of the peel-off sheet after the transfer of the first transfer layer or the second transfer layer;
a third supply unit for supplying a transfer target; and
a transfer unit for transferring the third transfer layer from which the region to be removed in the intermediate transfer medium is removed onto the transfer target.

17. A peel-off apparatus comprising:
a first supply unit for supplying an intermediate transfer medium including a support and a third transfer layer provided on one surface of the support so as to be separable from the support;
a second supply unit for supplying the thermal transfer sheet according to claim 1 or a combination of a thermal transfer sheet and a peel-off sheet; and
a peel-off unit for heating the thermal transfer sheet, transferring the first transfer layer or the second transfer layer of the thermal transfer sheet onto at least a portion of a region to be removed of the third transfer layer, and removing the region to be removed of the third transfer layer by the thermal transfer sheet or the peel-off layer of the peel-off sheet after the transfer of the first transfer layer or the second transfer layer.
